(19) United States
(12) Patent Application Publication
(10) Pub. No.: US 2026/0276499 A1
(43) Pub. Date: Sep. 17, 2026

(54) DEVICES AND METHODS FOR ANALYSIS OF MECHANICAL AND THERMAL LOADING OF STRUCTURES, AND METHODS FOR IMPROVING DESIGN PROCESSES FOR COMPONENTS OF SUCH STRUCTURES

(71) Applicant: The Boeing Company, Arlington, VA (US)

(72) Inventors: Joseph D. SCHAEFER, Richmond Heights, MO (US); Keith G. RACKERS, Florissant, MO (US); Paul B. DUFOUR, O'Fallon, MO (US); Matthew J. MOLITOR, O'Fallon, MO (US)

(73) Assignee: The Boeing Company, Arlington, VA (US)

(21) Appl. No.: 19/670,214

(22) Filed: May 7, 2026

Related U.S. Application Data
(63) Continuation-in-part of application No. 18/302,892, filed on Apr. 19, 2023, now Pat. No. 12,644,783.

(51) Int. Cl. G01N 3/02

(52) U.S. Cl. CPC G01N 3/02; G01N 2203/0222

(57) ABSTRACT

A method and a system for analysis of mechanical and thermal loading of a double-pin thermal-mechanical structure are disclosed. The system includes a test physical double-pin thermal-mechanical structure; a finite element model representative of the test physical double-pin thermal-mechanical structure; a processor configured to perform operations comprising: performing a thermal load test on the finite element model representative of the test physical double-pin thermal-mechanical structure over a range of parameters, the second plurality of parameters, and over a range of operating temperatures that the test physical double-pin thermal-mechanical structure is expected to experience; performing a mechanical stress test on the finite element model representative of the test physical double-pin thermal-mechanical structure over the plurality of parameters and over a range of operating temperatures that the test physical double-pin thermal-mechanical structure is expected to experience; and determining that the thermal load test and the mechanical stress test meet a predetermined threshold.

### CROSS-REFERENCE TO RELATED APPLICATIONS

This application is a continuation-in-part (CIP) of U.S. Patent Application Serial No. 18/302,892 filed on April 19, 2023, the contents of which are hereby incorporated by reference in its entirety.

### FIELD

The subject matter disclosed herein generally relates to devices for analysis of combined mechanical and thermal loading of structures. The subject matter disclosed herein also generally relates to methods for analysis of combined mechanical and thermal loading of structures. Additionally, the subject matter disclosed herein also generally relates to methods for improving design processes for components subjected to combined mechanical and thermal loading.

### BACKGROUND

In many industries, such as the aviation industry, significant reliance is placed on predicting combined mechanical and thermal loading of structures, calculating mechanical and thermal loading of structures, and on analysis of combined mechanical and thermal loading of structures. As a result, there exists a need to develop devices for analysis of such combined mechanical and thermal loading of structures. Such devices can be used in various methods for analysis of combined mechanical and thermal loading of structures. And such methods can be used in improving design processes for components that comprise those materials and other materials with similar physical properties.

Some aerospace design approaches/methods for predicting combined mechanical and thermal loading generate overly conservative results (e.g., predict failure loads much lower than the observed experimental failure loads). One particular method that sometimes suffers from this excessive conservatism is linear elastic Finite Element Analysis (“FEA”). The reason that linear elastic FEA will sometimes significantly underpredict the failure load is that the neglected plastic deformation and joint compliance in the structure (e.g., due to gaps between components) will relieve thermal-expansion-induced motion, thereby reducing the load. Although linear elastic FEA has shortcomings, it is used extensively in the aviation industry for full-vehicle analysis because alternate more exact analyses require significantly more labor, computational resources, and time.

When fastened joints/members of dissimilar materials (e.g., metallics and composite laminates) are heated and/or cooled, high thermally induced stresses result because the materials, which would expand and/or contract different amounts in the unrestrained state, are constrained to deflect the same amount by the presence of the joint. Therefore, the material that would expand less in the unrestrained state is stretched and the material that would expand more in the unrestrained state is compressed due to the different coefficients of thermal expansion between the materials within a same structural joint. Furthermore, the fasteners that join the dissimilar materials are subjected to high loads because they impose this constraint on the members.

Because of the issues discussed above, there is a need in many industries, such as the aerospace, automotive, defense, electronics, maritime, and rail-transport industries, for developing devices for analysis of combined mechanical and thermal loading of structures, for developing methods for analysis of combined mechanical and thermal loading of structures, and for improving design processes for components that comprise those materials and other materials with similar physical properties.

### SUMMARY

The present disclosure is directed to devices for analysis of combined mechanical and thermal loading of structures, methods for analysis of combined mechanical and thermal loading of structures, and/or methods for improving design processes for components subject to this loading.

In some examples, a device for analysis of mechanical and thermal loading of structures can comprise: a first member comprising first material; a second member comprising second material; and a third member comprising the first material. The second member can be at least partially between the first and third members. The second member can be fastened to the first and third members (e.g., in at least two locations along the length of the second member). The first material can differ from the second material. The device can be configured to mechanically load the first, second, and third members by applying equal and opposite force to protruding ends of the first, second, and third members (e.g., a force can be applied to the ends of the first and third members that extend beyond the second member and, at the same time, an equal and opposite force can be applied to the end of the second member that extends beyond the first and third members).

In some examples of the device, the first material can have a first coefficient of thermal expansion. The second material can have a second coefficient of thermal expansion. The first coefficient of thermal expansion can differ from the second coefficient of thermal expansion.

In some examples of the device, the first coefficient of thermal expansion can be greater than the second coefficient of thermal expansion.

In some examples of the device, the first coefficient of thermal expansion can be less than the second coefficient of thermal expansion.

In some examples of the device, the first material can comprise at least one metal.

In some examples of the device, the first material can comprise at least one non-metal.

In some examples of the device, the first material can comprise a composite laminate.

In some examples of the device, the second material can comprise at least one metal.

In some examples of the device, the second material can comprise at least one non-metal.

In some examples of the device, the second material can comprise at least one composite laminate.

In some examples, a device for analysis of mechanical and thermal loading of structures can comprise: a first member comprising first material; and a second member comprising second material. The first member can be at least partially between portions of the second member. The first member can be fastened to the second member (e.g., in at least two locations along the length of the second member). The first material can differ from the second material. The device can be configured to mechanically load the first and second members by applying equal and opposite force to protruding ends of the first and second members (e.g., a force can be applied to the end of the first members that extends beyond the second member and, at the same time, an equal and opposite force can be applied to the end of the second member that extends beyond the first member).

In some examples of the device, the first material can have a first coefficient of thermal expansion. The second material can have a second coefficient of thermal expansion. The first coefficient of thermal expansion can differ from the second coefficient of thermal expansion.

In some examples of the device, the first coefficient of thermal expansion can be greater than the second coefficient of thermal expansion.

In some examples of the device, the first coefficient of thermal expansion can be less than the second coefficient of thermal expansion.

In some examples, a method for analysis of mechanical and thermal loading of structures can comprise: selecting first, second, and third members; fastening the second member to the first and third members to form a device for the analysis (e.g., in at least two locations along the length of the second member), wherein the second member is at least partially between the first and third members; thermally loading the device by raising or lowering a temperature of the first, second, and third members; mechanically loading the device by applying equal and opposite force to protruding ends of the first, second, and third members (e.g., a force can be applied to the ends of the first and third members that extend beyond the second member and, at the same time, an equal and opposite force can be applied to the end of the second member that extends beyond the first and third members) until failure of a member or fastener occurs; and measuring a failure load or other relevant physical parameter of the device. The first member can comprise first material. The second member can comprise second material. The third member can comprise the first material.

In some examples of the method, the method can further comprise: determining one or more corrections for a thermal loading analysis based on the measured failure load or other relevant physical parameter of the device.

In some examples of the method, the method can further comprise: determining one or more corrections for a combined mechanical and thermal loading analysis based on the measured failure load or other relevant physical parameter of the device.

In some examples of the method, the first material can have a first coefficient of thermal expansion. The second material can have a second coefficient of thermal expansion. The first coefficient of thermal expansion can differ from the second coefficient of thermal expansion.

In some examples of the method, the first coefficient of thermal expansion can be greater than the second coefficient of thermal expansion.

In some examples of the method, the first coefficient of thermal expansion can be less than the second coefficient of thermal expansion.

In some examples of the method, the method can further comprise: fastening the first and third members to the second member (e.g., in at least two locations along the length of the second member) without generating axial load; and mechanically loading the first, second, and third members by applying equal and opposite force to protruding ends of the first, second, and third members (e.g., a force can be applied to the ends of the first and third members that extend beyond the second member and, at the same time, an equal and opposite force can be applied to the end of the second member that extends beyond the first and third members) until failure of a member or fastener occurs. This method should establish the failure load for mechanical-only loading.

In some examples of the method, the method can further comprise: raising or lowering the temperature of the first, second, and third members; fastening the first and third members to the second member (e.g., in at least two locations along the length of the second member) without generating axial load; and mechanically loading the first, second, and third members by applying equal and opposite force to protruding ends of the first, second, and third members (e.g., a force can be applied to the ends of the first and third members that extend beyond the second member and, at the same time, an equal and opposite force can be applied to the end of the second member that extends beyond the first and third members) until failure of a member or fastener occurs. This method should establish the failure load for mechanical-only loading.

In some examples of the method, the method can further comprise: determining corrections for simplified analyses based on a comparison between the measured and predicted failure loads for the tests subjected to combined thermal and mechanical loading and the tests subjected to only mechanical loading.

In some examples, a method for analysis of mechanical and thermal loading of structures and for determining corrections to simplified analyses can be accomplished for a two-member system in a manner analogous to the three-member system described above, where the first and third member have been combined into the first member.

In some examples, a device for analysis of mechanical and thermal loading of structures can comprise: a first member comprising first material; a second member comprising second material; and a third member comprising the first material. The second member can be at least partially between the first and third members. The second member can be fastened to the first and third members. The first material can differ from the second material. The device can be configured to mechanically load the first, second, and third members by applying equal and opposite force to protruding ends of the second member.

In some examples of the device, the first material can have a first coefficient of thermal expansion. The second material can have a second coefficient of thermal expansion. The first coefficient of thermal expansion can differ from the second coefficient of thermal expansion.

In some examples of the device, the first coefficient of thermal expansion can be greater than the second coefficient of thermal expansion.

In some examples of the device, the first coefficient of thermal expansion can be less than the second coefficient of thermal expansion.

It is to be understood that both the foregoing general description and the following detailed description are exemplary and explanatory only, and are not restrictive of the present teachings, as claimed.

### DRAWINGS

The above and/or other aspects and advantages will become more apparent and more readily appreciated from the following detailed description of examples, taken in conjunction with the accompanying drawings, in which:

FIG. 1A shows a device for analysis of combined mechanical and thermal loading of structures according to some examples of the disclosed apparatuses;

FIG. 1B shows a first member of the device of FIG. 1A;

FIG. 1C shows a second member of the device of FIG. 1A;

FIG. 1D shows a third member of the device of FIG. 1A;

FIG. 2A shows a device for analysis of combined mechanical and thermal loading of structures according to some examples of the disclosed apparatuses;

FIG. 2B shows a first member of the device of FIG. 2A;

FIG. 2C shows a second member of the device of FIG. 2A;

FIG. 3A shows a device for analysis of combined mechanical and thermal loading of structures according to some examples of the disclosed apparatuses;

FIG. 3B shows a first member of the device of FIG. 3A;

FIG. 3C shows a second member of the device of FIG. 3A;

FIG. 3D shows a third member of the device of FIG. 3A;

FIG. 4 shows a method for analysis of (e.g., determining failure loads for) combined mechanical and thermal loading of structures according to examples of the present disclosure;

FIG. 5 shows an improved method for analysis of (e.g., determining failure loads for) combined mechanical and thermal loading of structures;

FIG. 6 shows a method for designing large domain of joint configurations/conditions to achieve target ratios of thermal and mechanical loading according to examples of the present disclosure;

FIG. 7 shows a method for preparing the test structure for testing according to examples of the present disclosure;

FIG. 8 shows a plot of stress versus strain as provided by the analysis module for a test structure according to examples of the present disclosure;

FIG. 9 shows a series of failure modes that can be experienced by the test structures according to examples of the present disclosure. The test structure can experience net tension, shear-out, bearing deformation, cleavage deformation, and tearing;

FIG. 10 shows test structure where a fastener has failed due to a shear force, bending, or pull-out experienced by components of the test structure, according to examples of the present disclosure;

FIG. 11 shows test structure with pin spacing identified between two fastener locations, which can be used during the analysis performed by the analysis module, according to examples of the present disclosure;

FIG. 12 shows a plot of theoretical assumptions and physical test and inspection data, which can be used during the analysis performed by the analysis module, according to examples of the present disclosure;

FIG. 13 shows a table showing relevant technical data based on any of the pertinent parametric aspects of the joint design (e.g., hole diameters, material thickness, fastener spacing, clamp-up level of the joint hardware, etc. ) to quantify the percentage of thermal load for the test structure with different fastener-to-fastener distances, according to examples of the present disclosure;

FIG. 14 shows a table of various results that can be produced by the analysis module for a variety of lengths between fasteners for a test structure, according to examples of the present disclosure;

FIG. 15 shows a plot of a correction factor verses length between fasteners based on any of the above-noted pertinent parametric parameters comparing data from the analysis module with curved fitted data according to examples of the present disclosure; and

FIG. 16 shows a computer system according to examples of the present disclosure.

### DETAILED DESCRIPTION

Exemplary aspects will now be described more fully with reference to the accompanying drawings. Examples of the disclosure, however, can be embodied in many different forms and should not be construed as being limited to the examples set forth herein. Rather, these examples are provided so that this disclosure will be thorough and complete, and will fully convey the scope to a person having ordinary skill in the art (“PHOSITA”). In the drawings, some details may be simplified and/or may be drawn to facilitate understanding rather than to maintain strict structural accuracy, detail, and/or scale. For example, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, or section could be termed a second element, component, region, layer, or section without departing from the teachings of examples.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation(s) depicted in the figures.

The terminology used herein is for the purpose of describing particular examples only and is not intended to be limiting of examples. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as understood by a PHOSITA. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

The present disclosure is generally directed to devices for analysis of combined mechanical and thermal loading of structures. The present disclosure also is generally directed to methods for analysis of combined mechanical and thermal loading of structures. Additionally, the present disclosure is generally directed to methods for improving design processes for components subject to such loading.

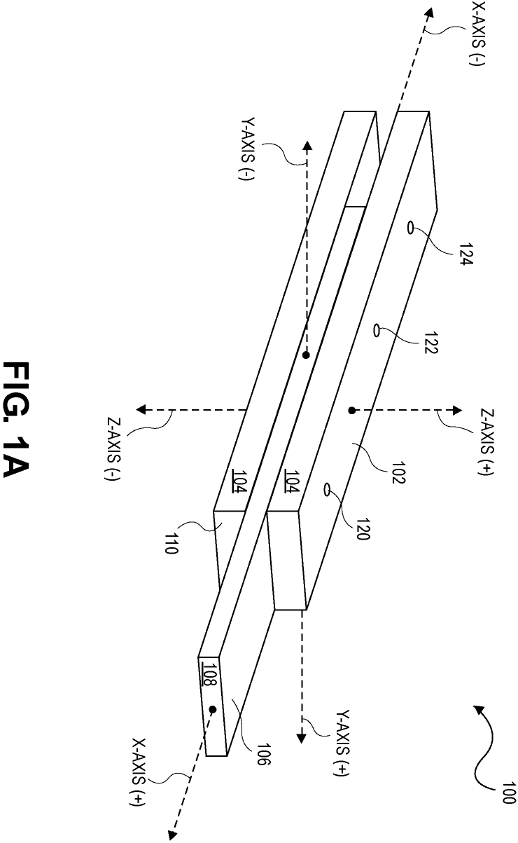

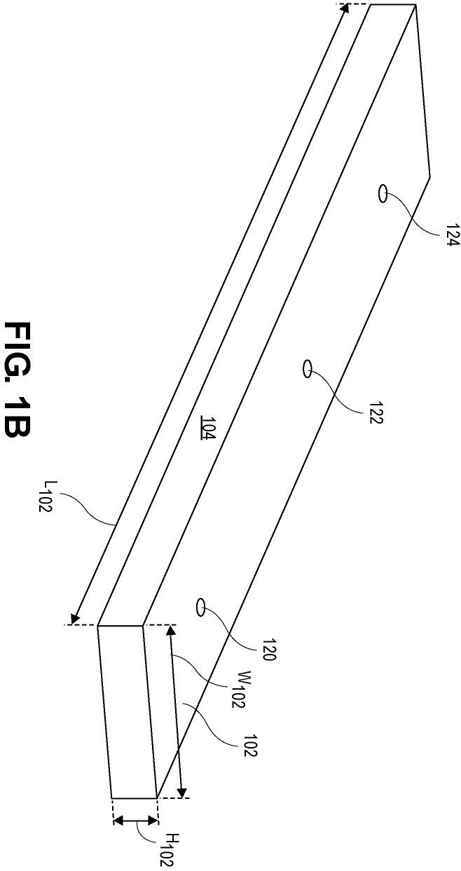

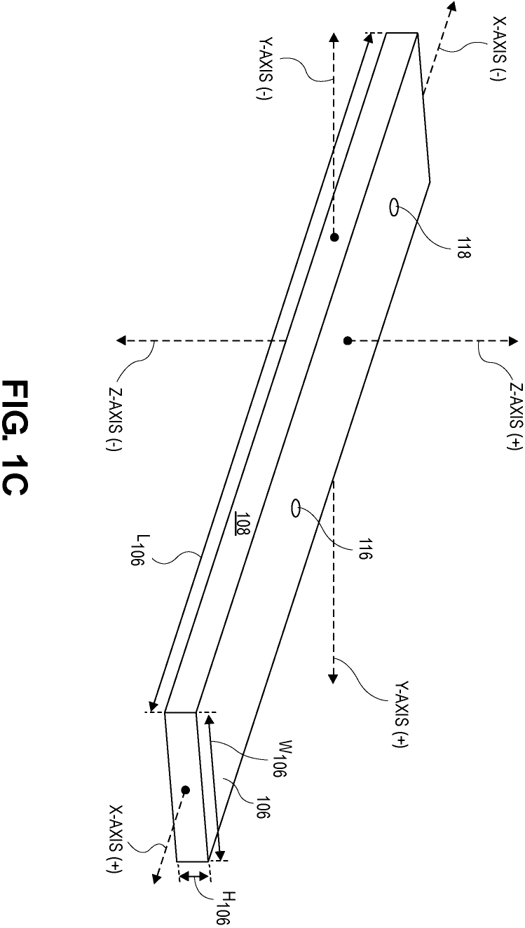

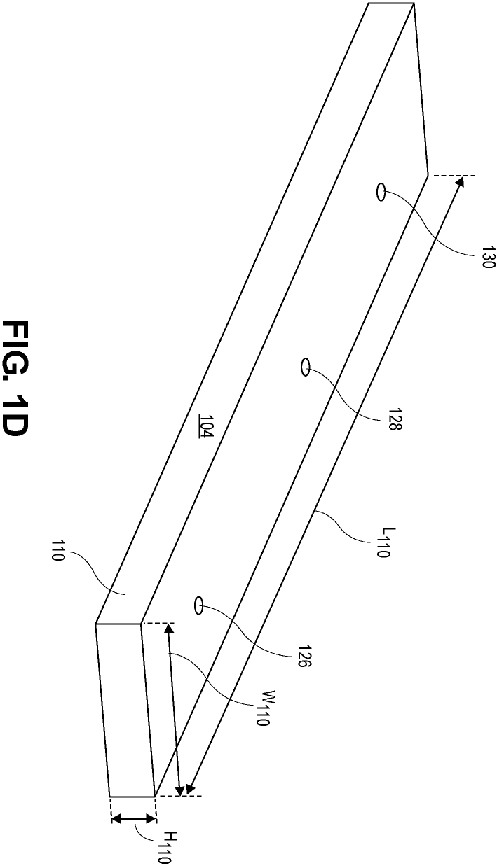

FIGS. 1A, 1B, 1C and 1D show device 100 for analysis of combined mechanical and thermal loading of structures, according to some examples of the disclosed apparatuses.

As shown in FIGS. 1A, 1B, 1C and 1D, device 100 for analysis of combined mechanical and thermal loading of structures can comprise: first member 102 comprising first material 104; second member 106 comprising second material 108; and third member 110 comprising first material 104. First material 104 can differ from second material 108.

Second member 106 can be at least partially between first member 102 and third member 110. Second member 106 can be attached to first member 102 and third member 110 in at least two locations along the length of second member 106 using, for example, fasteners (not shown) commonly employed in the aviation industry (e.g., aerospace fasteners, bolts, or rivets).

Device 100 can be configured to mechanically load first member 102, second member 106, and third member 110 by applying force to the ends of first member 102 and third member 110 that extend beyond second member 106 and, at the same time, by applying equal and opposite force to the end of second member 106 that extends beyond first member 102 and third member 110. For example, such forces can be applied to first member 102 and third member 110, while holding second member 106, using a universal testing machine, as discussed below.

First material 104 can comprise at least one metal, such as aluminum or aluminum alloy, nickel or nickel alloy, niobium or niobium alloy, magnesium or magnesium alloy, steel or steel alloy, titanium or titanium alloy, tungsten or tungsten alloy, or vanadium or vanadium alloy. As would be understood by a PHOSITA, selection of materials for first material 104 can be tailored to produce various coefficients of thermal expansion for thermal loading.

In addition, or in the alternative, first material 104 can comprise an additively manufactured metal part. First material 104 can comprise at least one non-metal, at least one polymer, or a composite laminate. In addition, or in the alternative, first material 104 can comprise an additively manufactured polymer part.

Such a composite laminate of first material 104 can comprise reinforcing fibers, such as carbon fibers, glass fibers, or carbon fibers and glass fibers. Such fibers may have no specific orientation (e.g., omnidirectional) or may be oriented in one or more directions (e.g., unidirectional, bidirectional, or multidirectional). The fibers may be aligned, continuous, discontinuous, and/or unidirectional.

The composite laminate can comprise, for example, continuous fibers, short fibers, pre-preg unidirectional tape, pre-preg fabric, a combination of pre-preg tape and fabric layers to create a hybrid laminate, or fabric or unidirectional fibers infused by resin and cured into a laminate. As would be understood by a PHOSITA, selection of materials and/or orientation of layers within such a composite laminate of first material 104 can be tailored to produce various coefficients of thermal expansion for thermal loading.

Second material 108 can comprise at least one metal, such as aluminum or aluminum alloy, nickel or nickel alloy, niobium or niobium alloy, magnesium or magnesium alloy, steel or steel alloy, titanium or titanium alloy, tungsten or tungsten alloy, or vanadium or vanadium alloy. As would be understood by a PHOSITA, selection of materials for second material 108 can be tailored to produce various coefficients of thermal expansion for thermal loading.

In addition, or in the alternative, second material 108 can comprise an additively manufactured metal part. Second material 108 can comprise at least one non-metal, at least one polymer, or a composite laminate. In addition, or in the alternative, second material 108 can comprise an additively manufactured polymer part.

Such a composite laminate of second material 108 can comprise reinforcing fibers, such as carbon fibers, glass fibers, or carbon fibers and glass fibers. Such fibers may have no specific orientation (e.g., omnidirectional) or may be oriented in one or more directions (e.g., unidirectional, bidirectional, or multidirectional). The fibers may be aligned, continuous, discontinuous, and/or unidirectional.

The composite laminate can comprise, for example, continuous fibers, short fibers, pre-preg unidirectional tape, pre-preg fabric, a combination of pre-preg tape and fabric layers to create a hybrid laminate, or fabric or unidirectional fibers infused by resin and cured into a laminate. As would be understood by a PHOSITA, selection of materials and/or orientation of layers within such a composite laminate of second material 108 can be tailored to produce various coefficients of thermal expansion for thermal loading.

In a first example, first material 104 can comprise at least one metal, such as aluminum or aluminum alloy, and second material 108 can comprise a composite laminate comprising carbon fibers. In a second example, first material 104 can comprise a composite laminate comprising glass fibers, and second material 108 can comprise at least one metal, such as titanium or titanium alloy.

Because first member 102 and third member 110 comprise first material 104, first member 102 and third member 110 have a first coefficient of thermal expansion. Because second member 106 comprises second material 108, second member 106 has a second coefficient of thermal expansion.

For analysis of combined mechanical and thermal loading of structures, it is desired that the first coefficient of thermal expansion differ from the second coefficient of thermal expansion. Under some testing conditions, the first coefficient of thermal expansion can be greater than the second coefficient of thermal expansion, while under other testing conditions, the first coefficient of thermal expansion can be less than the second coefficient of thermal expansion.

As shown in FIGS. 1A and 1C, in order to simplify calculations, estimates, measurements, and other issues associated with analysis of combined mechanical and thermal loading of structures, second member 106 can comprise a substantially flat, rectangular plate having length L₁₀₆, width W₁₀₆, and height H₁₀₆. Example values include: length L₁₀₆ (e.g., 5”-100”, 7.5”-50”, or 10”-25”—such as 6.5”, 9.5”, 10”, 11.5”, 13.5”, 14.5”, 15”, 18.5”, 20”, 23.5”, or 24.5”); width W₁₀₆ (e.g., 1”-10”, 1.5”-5”, or 2”-4”—such as 1.5”, 2”, 2.5”, or 3”); and height H₁₀₆ (e.g., 0.05”-0.60”, 0.06”-0.30”, or 0.075”-0.15”—such as 0.08”, 0.09”, 0.10”, or 0.135”).

Although other shapes could be used for second member 106, such as a plate with a circular, triangular, pentagonal, hexagonal, or other cross section (rather than a rectangular cross section) or a plate whose overall shape resembles a circle, ellipse, oval, parallelogram, rhombus, trapezoid, or other FIGURE(rather than a rectangle), a PHOSITA would recognize that such alternate cross sections and/or overall shapes could add complexity to the calculations, estimates, measurements, and other issues associated with the analysis of combined mechanical and thermal loading of structures.

As also shown in FIGS. 1A and 1C, second member 106 can define a three-dimensional (“3D”) coordinate-axis system for device 100 that includes an X-axis along length L₁₀₆, a Y-axis along width W₁₀₆, and a Z-axis along height H₁₀₆ in which the positive directions for the axes follow the right-hand rule. When second member 106 is a substantially flat, rectangular, homogeneous plate, the center of mass of second member 106 should lie on the X-axis.

In order to facilitate fastening second member 106 to first member 102 and third member 110, second member 106 can include through holes 116 and 118. Through holes 116 and 118 should lie along the X-axis and the direction of through holes 116 and 118 should be parallel to the Z-axis. Although a PHOSITA would recognize that other approaches for fastening second member 106 to first member 102 and third member 110 can be used, through holes that are aligned and penetrate first member 102, second member 106, and third member 110 provide an approach that is simple, efficient, effective, and should provide repeatable testing results.

In order to simplify calculations, estimates, measurements, and other issues associated with analysis of combined mechanical and thermal loading of structures, when second member 106 is mechanically loaded by first member 102 and third member 110, the mechanical load on second member 106 from first member 102 should be equal to the mechanical load on second member 106 from third member 110, so that the net mechanical load is applied along the X-axis. Because of this net mechanical loading along the X-axis, second member 106 should not have a tendency to bend, curl, or twist, and should not have a tendency to move along the Y-axis, to move along the Z-axis, to roll with respect to the X-axis, to pitch with respect to the Y-axis, or to yaw with respect to the Z-axis.

As shown in FIGS. 1A and 1B, in order to simplify calculations, estimates, measurements, and other issues associated with analysis of combined mechanical and thermal loading of structures, first member 102 can comprise a substantially flat, rectangular plate having length L₁₀₂, width W₁₀₂, and height H₁₀₂. First member 102 can be, for example, thickened at one end for increased strength. Example values include: length L₁₀₂ (e.g., 5”-100”, 7.5”-50”, or 10”-25”—such as 6.5”, 9.5”, 10”, 11.5”, 13.5”, 14.5”, 15”, 18.5”, 20”, 23.5”, or 24.5”); width W₁₀₂ (e.g., 1”-10”, 1.5”-5”, or 2”-4”—such as 1.5”, 2”, 2.5”, or 3”); and height H₁₀₂ (e.g., 0.05”-0.60”, 0.06”-0.30”, or 0.075”-0.15”—such as 0.08”, 0.09”, 0.10”, or 0.135”).

Although other shapes could be used for first member 102, such as a plate with a circular, triangular, pentagonal, hexagonal, or other cross section (rather than a rectangular cross section) or a plate whose overall shape resembles a circle, ellipse, oval, parallelogram, rhombus, trapezoid, or other FIGURE(rather than a rectangle), a PHOSITA would recognize that such alternate cross sections and/or overall shapes could add complexity to the calculations, estimates, measurements, and other issues associated with the analysis of combined mechanical and thermal loading of structures.

As shown in FIG. 1A, when assembling device 100, first member 102 can be substantially aligned with second member 106 along the X-axis.

In order to facilitate fastening second member 106 to first member 102, first member 102 can include through holes 120 and 122. When assembling device 100, through holes 120 and 122 should lie along the X-axis and the direction of through holes 120 and 122 should be parallel to the Z-axis. Although a PHOSITA would recognize that other approaches for fastening second member 106 to first member 102 can be used, through holes that are aligned and penetrate first member 102, second member 106, and third member 110 provide an approach that is simple, efficient, effective, and should provide repeatable testing results.

As shown in FIGS. 1A and 1D, in order to simplify calculations, estimates, measurements, and other issues associated with analysis of combined mechanical and thermal loading of structures, third member 110 can comprise a substantially flat, rectangular plate having length L₁₁₀, width W₁₁₀, and height H₁₁₀. Third member 110 can be, for example, thickened at one end for increased strength. Example values include: length L₁₁₀ (e.g., 5”-100”, 7.5”-50”, or 10”-25”—such as 6.5”, 9.5”, 10”, 11.5”, 13.5”, 14.5”, 15”, 18.5”, 20”, 23.5”, or 24.5”); width W₁₁₀ (e.g., 1”-10”, 1.5”-5”, or 2”-4”—such as 1.5”, 2”, 2.5”, or 3”); and height H₁₁₀ (e.g., 0.05”-0.60”, 0.06”-0.30”, or 0.075”-0.15”—such as 0.08”, 0.09”, 0.10”, or 0.135”).

Although other shapes could be used for third member 110, such as a plate with a circular, triangular, pentagonal, hexagonal, or other cross section (rather than a rectangular cross section) or a plate whose overall shape resembles a circle, ellipse, oval, parallelogram, rhombus, trapezoid, or other FIGURE(rather than a rectangle), a PHOSITA would recognize that such alternate cross sections and/or overall shapes could add complexity to the calculations, estimates, measurements, and other issues associated with the analysis of combined mechanical and thermal loading of structures.

As shown in FIG. 1A, when assembling device 100, third member 110 can be substantially aligned with second member 106 along the X-axis.

In order to facilitate fastening second member 106 to third member 110, third member 110 can include through holes 126 and 128. When assembling device 100, through holes 126 and 128 should lie along the X-axis and the direction of through holes 126 and 128 should be parallel to the Z-axis. Although a PHOSITA would recognize that other approaches for fastening second member 106 to third member 110 can be used, through holes that are aligned and penetrate first member 102, second member 106, and third member 110 provide an approach that is simple, efficient, effective, and should provide repeatable testing results.

In order to simplify calculations, estimates, measurements, and other issues associated with analysis of combined mechanical and thermal loading of structures, when load is applied to first member 102 at through hole 124 and to third member 110 at through hole 130 (both as discussed below), while simultaneously holding the opposite end of second member 106, the mechanical load on first member 102 should be equal to the mechanical load on third member 110, so that the net mechanical load is applied along the X-axis. Because of this net mechanical loading along the X-axis and the presence of second member 106, third member 110 should not have a tendency to bend, curl, or twist, and should not have a tendency to move along the Y-axis, to move along the Z-axis, to roll with respect to the X-axis, to pitch with respect to the Y-axis, or to yaw with respect to the Z-axis.

When first member 102 and third member 110 are mechanically loaded while holding second member 106, a distance in the X-axis direction between fasteners joining first member 102 and third member 110 to second member 106 can increase.

Device 100 can be configured to apply force to first member 102 at through hole 124 (e.g., the protruding end of first member 102) and to third member 110 at through hole 130 (e.g., the protruding end of third member 110) while holding the opposite end of second member 106 (e.g., the protruding end of second member 106). A first load path is through first member 102, between through hole 124 and through hole 122, through a fastener in through hole 122 in first member 102 and through hole 118 in second member 106, and through second member 106 between through hole 118 and the protruding end of second member 106. A second load path is through first member 102 between through hole 124 and through hole 120, through a fastener in through hole 120 in first member 102 and through hole 116 in second member 106, and through second member 106 between through hole 116 and the protruding end of second member 106. A third load path is through third member 110, between through hole 130 and through hole 128, through a fastener in through hole 128 in third member 110 and through hole 118 in second member 106, and through second member 106 between through hole 118 and the protruding end of second member 106. A fourth load path is through third member 110 between through hole 130 and through hole 126, through a fastener in through hole 126 in third member 110 and through hole 116 in second member 106, and through second member 106 between through hole 116 and the protruding end of second member 106.

As discussed above, first member 102 can comprise a first plate, second member 106 can comprise a second plate, and third member 110 can comprise a third plate. One or more plates of the first, second, and third plates can comprise a substantially flat, rectangular plate. As discussed above, a PHOSITA would recognize that alternate cross sections and/or overall shapes, although useable, could add complexity to the calculations, estimates, measurements, and other issues associated with the analysis of combined mechanical and thermal loading of structures.

The first and third plates can lie in parallel geometric planes. The first, second, and third plates can lie in parallel geometric planes. As used herein, the term “geometric plane” is intended to distinguish the word “plane” as used in the field of geometry from the word “plane” as used in the aviation industry.

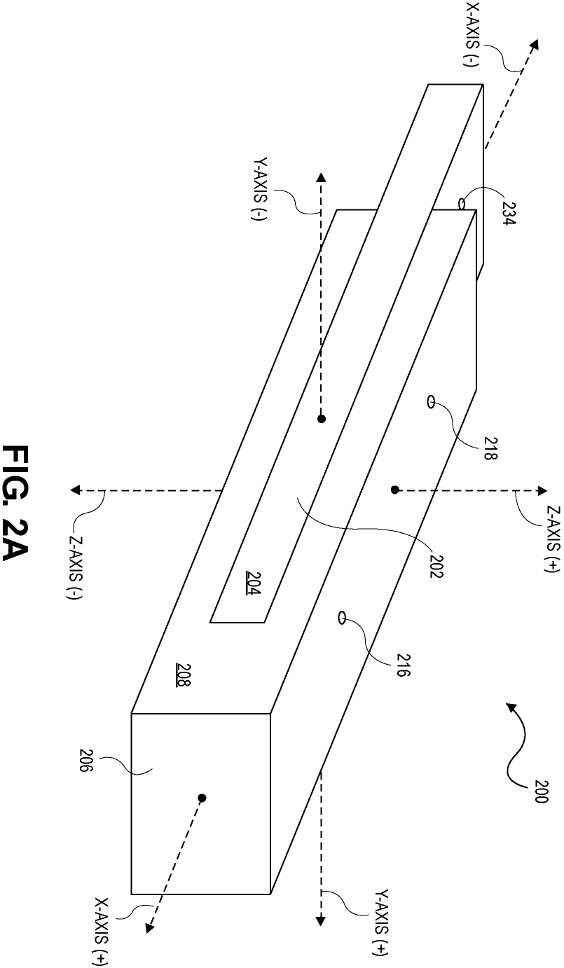

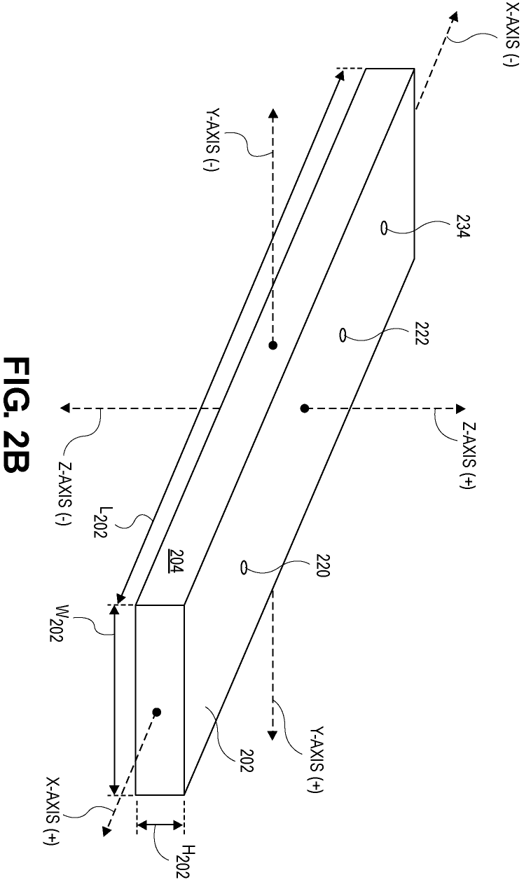

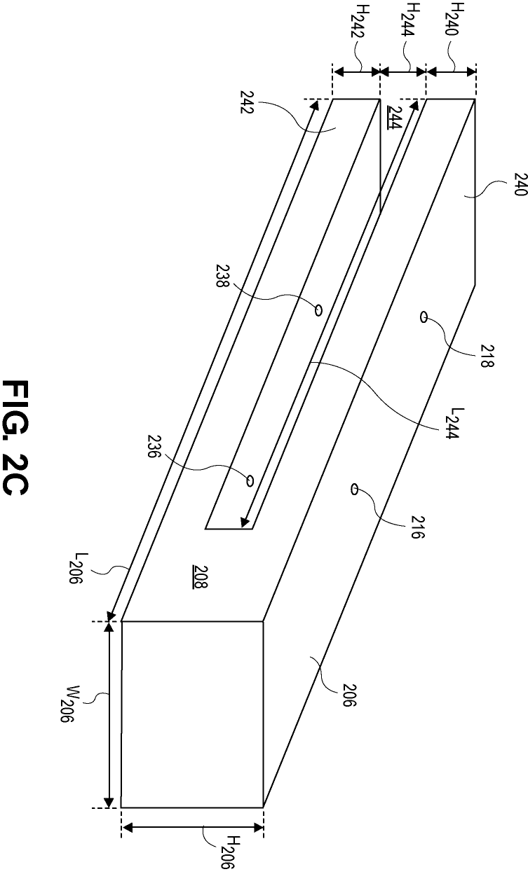

FIGS. 2A, 2B and 2C show device 200 for analysis of combined mechanical and thermal loading of structures, according to some examples of the disclosed apparatuses.

As shown in FIGS. 2A, 2B and 2C, device 200 for analysis of combined mechanical and thermal loading of structures can comprise: first member 202 comprising first material 204; and second member 206 comprising second material 208. First material 204 can differ from second material 208.

Second member 206 can be at least partially around first member 202. First member 202 can be attached to second member 206 in at least two locations along the length of first member 202 using, for example, fasteners (not shown) commonly employed in the aviation industry (e.g., aerospace fasteners, bolts, or rivets).

Device 200 can be configured to mechanically load first member 202 and second member 206 by applying force to the end of first member 202 that extends beyond second member 206 and, at the same time, by applying equal and opposite force to the end of second member 206 that extends beyond the end of first member 202. For example, such forces can be applied to first member 202 and second member 206 using a universal testing machine, as discussed below.

First material 204 can comprise at least one metal, such as aluminum or aluminum alloy, nickel or nickel alloy, niobium or niobium alloy, magnesium or magnesium alloy, steel or steel alloy, titanium or titanium alloy, tungsten or tungsten alloy, or vanadium or vanadium alloy. As would be understood by a PHOSITA, selection of materials for first material 204 can be tailored to produce various coefficients of thermal expansion for thermal loading.

In addition, or in the alternative, first material 204 can comprise an additively manufactured metal part. First material 204 can comprise at least one non-metal, at least one polymer, or a composite laminate. In addition, or in the alternative, first material 204 can comprise an additively manufactured polymer part.

Such a composite laminate of first material 204 can comprise reinforcing fibers, such as carbon fibers, glass fibers, or carbon fibers and glass fibers. Such fibers may have no specific orientation (e.g., omnidirectional) or may be oriented in one or more directions (e.g., unidirectional, bidirectional, or multidirectional). The fibers may be aligned, continuous, discontinuous, and/or unidirectional.

The composite laminate can comprise, for example, continuous fibers, short fibers, pre-preg unidirectional tape, pre-preg fabric, a combination of pre-preg tape and fabric layers to create a hybrid laminate, or fabric or unidirectional fibers infused by resin and cured into a laminate. As would be understood by a PHOSITA, selection of materials and/or orientation of layers within such a composite laminate of first material 204 can be tailored to produce various coefficients of thermal expansion for thermal loading.

Second material 208 can comprise at least one metal, such as aluminum or aluminum alloy, nickel or nickel alloy, niobium or niobium alloy, magnesium or magnesium alloy, steel or steel alloy, titanium or titanium alloy, tungsten or tungsten alloy, or vanadium or vanadium alloy. As would be understood by a PHOSITA, selection of materials for second material 208 can be tailored to produce various coefficients of thermal expansion for thermal loading.

In addition, or in the alternative, second material 208 can comprise an additively manufactured metal part. Second material 208 can comprise at least one non-metal, at least one polymer, or a composite laminate. In addition, or in the alternative, second material 208 can comprise an additively manufactured polymer part.

Such a composite laminate of second material 208 can comprise reinforcing fibers, such as carbon fibers, glass fibers, or carbon fibers and glass fibers. Such fibers may have no specific orientation (e.g., omnidirectional) or may be oriented in one or more directions (e.g., unidirectional, bidirectional, or multidirectional). The fibers may be aligned, continuous, discontinuous, and/or unidirectional.

The composite laminate can comprise, for example, continuous fibers, short fibers, pre-preg unidirectional tape, pre-preg fabric, a combination of pre-preg tape and fabric layers to create a hybrid laminate, or fabric or unidirectional fibers infused by resin and cured into a laminate. As would be understood by a PHOSITA, selection of materials and/or orientation of layers within such a composite laminate of second material 208 can be tailored to produce various coefficients of thermal expansion for thermal loading.

In a first example, first material 204 can comprise at least one metal, such as tungsten or tungsten alloy, and second material 208 can comprise a hybrid laminate. In a second example, first material 204 can comprise a composite laminate comprising carbon fibers and glass fibers, and second material 208 can comprise at least one metal, such as steel or steel alloy.

Because first member 202 comprises first material 204, first member 202 has a first coefficient of thermal expansion. Because second member 206 comprises second material 208, second member 206 has a second coefficient of thermal expansion.

For analysis of combined mechanical and thermal loading of structures, it is desired that the first coefficient of thermal expansion differ from the second coefficient of thermal expansion. Under some testing conditions, the first coefficient of thermal expansion can be greater than the second coefficient of thermal expansion, while under other testing conditions, the first coefficient of thermal expansion can be less than the second coefficient of thermal expansion.

As shown in FIGS. 2A and 2B, in order to simplify calculations, estimates, measurements, and other issues associated with analysis of combined mechanical and thermal loading of structures, first member 202 can comprise a substantially flat, rectangular plate having length L₂₀₂, width W₂₀₂, and height H₂₀₂. Example values include: length L₂₀₂ (e.g., 5”-100”, 7.5”-50”, or 10”-25”—such as 6.5”, 9.5”, 10”, 11.5”, 13.5”, 14.5”, 15”, 18.5”, 20”, 23.5”, or 24.5”); width W₂₀₂ (e.g., 1”-10”, 1.5”-5”, or 2”-4”—such as 1.5”, 2”, 2.5”, or 3”); and height H₂₀₂ (e.g., 0.05”-0.60”, 0.06”-0.30”, or 0.075”-0.15”—such as 0.08”, 0.09”, 0.10”, or 0.135”).

Although other shapes could be used for first member 202, such as a plate with a circular, triangular, pentagonal, hexagonal, or other cross section (rather than a rectangular cross section) or a plate whose overall shape resembles a circle, ellipse, oval, parallelogram, rhombus, trapezoid, or other FIGURE(rather than a rectangle), a PHOSITA would recognize that such alternate cross sections and/or overall shapes could add complexity to the calculations, estimates, measurements, and other issues associated with the analysis of combined mechanical and thermal loading of structures.

As also shown in FIGS. 2A and 2B, first member 202 can define a 3D coordinate-axis system for device 200 that includes an X-axis along length L₂₀₂, a Y-axis along width W₂₀₂, and a Z-axis along height H₂₀₂ in which the positive directions for the axes follow the right-hand rule. When first member 202 is a substantially flat, rectangular, homogeneous plate, the center of mass of first member 202 should lie on the X-axis.

In order to facilitate fastening first member 202 to second member 206, first member 202 can include through holes 220 and 222. Through holes 220 and 222 should lie along the X-axis and the direction of through holes 220 and 222 should be parallel to the Z-axis. Although a PHOSITA would recognize that other approaches for fastening first member 202 to second member 206 can be used, through holes that are aligned and penetrate first member 202 to second member 206 provide an approach that is simple, efficient, effective, and should provide repeatable testing results.

As shown in FIGS. 2A and 2C, in order to simplify calculations, estimates, measurements, and other issues associated with analysis of combined mechanical and thermal loading of structures, second member 206 can comprise a substantially U-shaped plate having length L₂₀₆, width W₂₀₆, and height H₂₀₆. Example values include: length L₂₀₆ (e.g., 5”-100”, 7.5”-50”, or 10”-25”—such as 6.5”, 9.5”, 10”, 11.5”, 13.5”, 14.5”, 15”, 18.5”, 20”, 23.5”, or 24.5”); length L₂₄₄ (e.g., 4”-75”, 5”-50”, or 6”-25”—such as 5”, 6”, 8”, 10”, 12.5”, 15”, 17.5”, or 20”); width W₂₀₆ (e.g., 1”-10”, 1.5”-5”, or 2”-4”—such as 1.5”, 2”, 2.5”, or 3”); height H₂₀₆ (e.g., 0.15”-1.80”, 0.18”-0.90”, or 0.225”-0.45”—such as 0.24”, 0.27”, 0.30”, or 0.405”); height H₂₄₀ (e.g., 0.05”-0.60”, 0.06”-0.30”, or 0.075”-0.15”—such as 0.08”, 0.09”, 0.10”, or 0.135”); height H₂₄₂ (e.g., 0.05”-0.60”, 0.06”-0.30”, or 0.075”-0.15”—such as 0.08”, 0.09”, 0.10”, or 0.135”); and height H₂₄₄ (e.g., 0.05”-0.60”, 0.06”-0.30”, or 0.075”-0.15”—such as 0.08”, 0.09”, 0.10”, or 0.135”).

As also shown in FIGS. 2A and 2C, second member 206 can comprise upper portion 240 having height H₂₄₀, lower portion 242 having height H₂₄₂, and gap 244 having length L₂₄₄ and height H₂₄₄.

As shown in FIG. 2A, when assembling device 200, first member 202 can be substantially aligned with second member 206 along the X-axis.

In order to facilitate fastening second member 206 to first member 202, upper portion 240 of second member 206 can include through holes 216 and 218 and lower portion 242 of second member 206 can include through holes 236 and 238. When assembling device 200, through holes 216, 218, 236, and 238 should lie along the X-axis and the direction of through holes 216, 218, 236, and 238 should be parallel to the Z-axis. Although a PHOSITA would recognize that other approaches for fastening second member 206 to first member 202 can be used, through holes that are aligned and penetrate first member 202 and second member 206 provide an approach that is simple, efficient, effective, and should provide repeatable testing results.

In order to simplify calculations, estimates, measurements, and other issues associated with analysis of combined mechanical and thermal loading of structures, when first member 202 and second member 206 are mechanically loaded, the mechanical load on upper portion 240 of second member 206 from first member 202 should be equal to the mechanical load on lower portion 242 of second member 206 from first member 202, so that the net mechanical load is applied along the X-axis. Because of this net mechanical loading along the X-axis, first member 202 should not have a tendency to bend, curl, or twist, and should not have a tendency to move along the Y-axis, to move along the Z-axis, to roll with respect to the X-axis, to pitch with respect to the Y-axis, or to yaw with respect to the Z-axis. Similarly, because of this net mechanical loading along the X-axis, second member 206 should not have a tendency to bend, curl, or twist, and should not have a tendency to move along the Y-axis, to move along the Z-axis, to roll with respect to the X-axis, to pitch with respect to the Y-axis, or to yaw with respect to the Z-axis.

When first member 202 and second member 206 are mechanically loaded, a distance in the X-axis direction between fasteners joining first member 202 and second member 206 can increase.

Device 200 can be configured to apply force to first member 202 at through hole 234 (e.g., the protruding end of first member 202) while holding the opposite end of second member 206 (e.g., the protruding end of second member 206).

A first load path is through first member 202, between through hole 234 and through hole 222, through a fastener in through hole 222 in first member 202 and through hole 218 in upper portion 240 of second member 206, and through second member 206 between through hole 218 and the protruding end of second member 206. A second load path is through first member 202, between through hole 234 and through hole 220, through a fastener in through hole 220 in first member 202 and through hole 216 in upper portion 240 of second member 206, and through second member 206 between through hole 216 and the protruding end of second member 206. A third load path is through first member 202, between through hole 234 and through hole 222, through a fastener in through hole 222 in first member 202 and through hole 238 in lower portion 242 of second member 206, and through second member 206 between through hole 238 and the protruding end of second member 206. A fourth load path is through first member 202, between through hole 234 and through hole 220, through a fastener in through hole 220 in first member 202 and through hole 236 in lower portion 242 of second member 206, and through second member 206 between through hole 236 and the protruding end of second member 206.

As discussed above, first member 202 can comprise a first plate, upper portion 240 of second member 206 can comprise a second plate, and lower portion 242 of second member 206 can comprise a third plate. One or more plates of the first, second, and third plates can comprise a substantially flat, rectangular plate. As discussed above, a PHOSITA would recognize that alternate cross sections and/or overall shapes, although useable, could add complexity to the calculations, estimates, measurements, and other issues associated with the analysis of combined mechanical and thermal loading of structures.

The second and third plates can lie in parallel geometric planes. The first, second, and third plates can lie in parallel geometric planes.

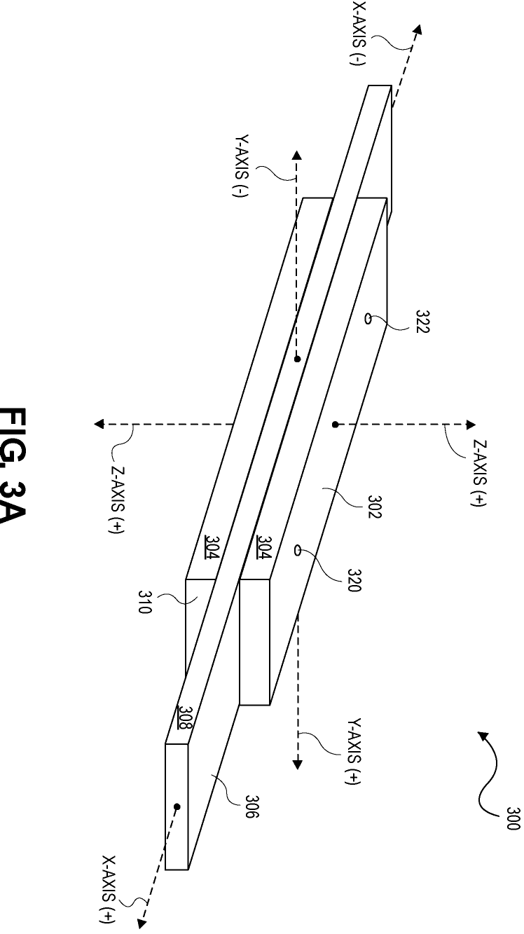

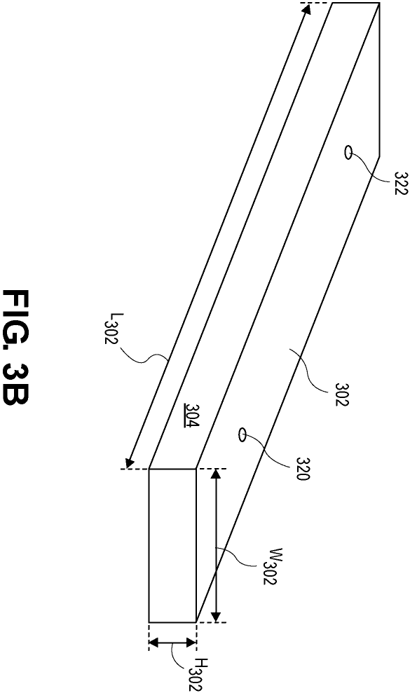

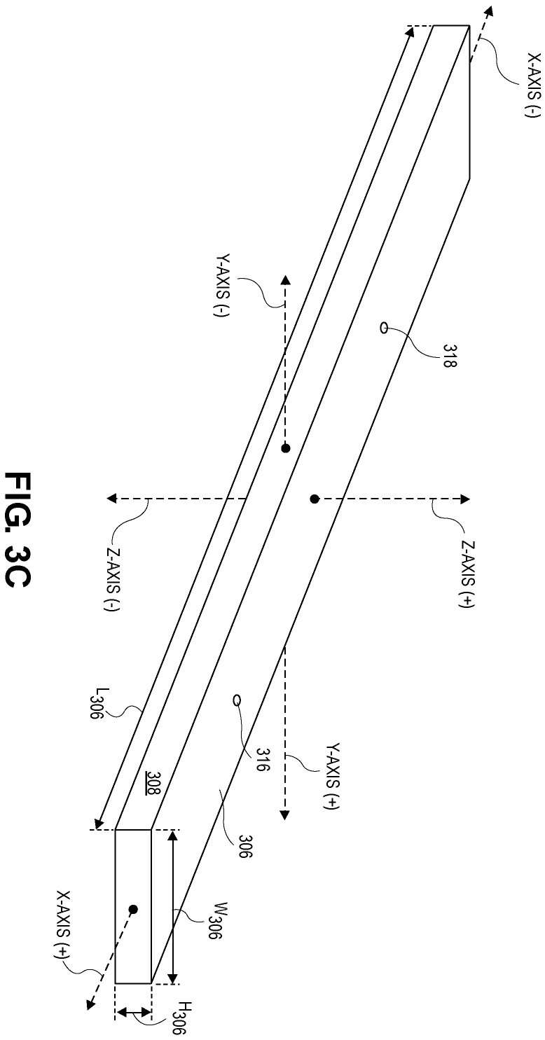

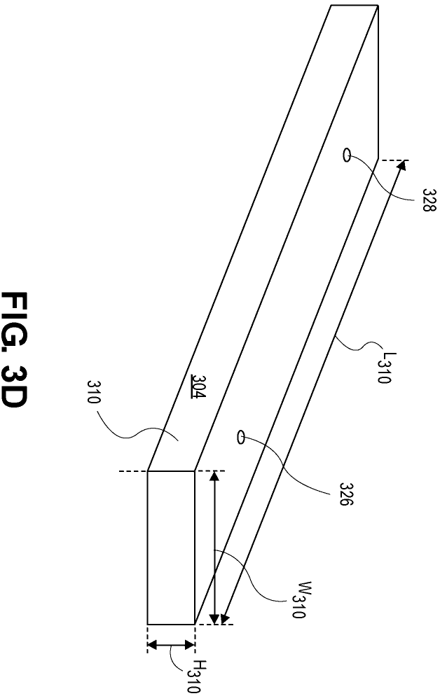

FIGS. 3A, 3B, 3C and 3D show device 300 for analysis of combined mechanical and thermal loading of structures, according to some examples of the disclosed apparatuses.

As shown in FIGS. 3A, 3B, 3C and 3D, device 300 for analysis of combined mechanical and thermal loading of structures can comprise: first member 302 comprising first material 304; second member 306 comprising second material 308; and third member 310 comprising first material 304. First material 304 can differ from second material 308.

Second member 306 can be at least partially between first member 302 and third member 310. Second member 306 can be attached to first member 302 and third member 310 in at least two locations along the length of second member 306 using, for example, fasteners (not shown) commonly employed in the aviation industry (e.g., aerospace fasteners, bolts, or rivets).

Device 300 can be configured to mechanically load first member 302, second member 306, and third member 310 by applying force to a first end of second member 306 that extends beyond the ends of first member 302 and third member 310 and, at the same time, by applying equal and opposite force to a second end of second member 306 that extends beyond the ends of first member 302 and third member 310. For example, such forces can be applied to second member 306 using a universal testing machine, as discussed below.

First material 304 can comprise at least one metal, such as aluminum or aluminum alloy, nickel or nickel alloy, niobium or niobium alloy, magnesium or magnesium alloy, steel or steel alloy, titanium or titanium alloy, tungsten or tungsten alloy, or vanadium or vanadium alloy. As would be understood by a PHOSITA, selection of materials for first material 304 can be tailored to produce various coefficients of thermal expansion for thermal loading.

In addition, or in the alternative, first material 304 can comprise an additively manufactured metal part. First material 304 can comprise at least one non-metal, at least one polymer, or a composite laminate. In addition, or in the alternative, first material 304 can comprise an additively manufactured polymer part.

Such a composite laminate of first material 304 can comprise reinforcing fibers, such as carbon fibers, glass fibers, or carbon fibers and glass fibers. Such fibers may have no specific orientation (e.g., omnidirectional) or may be oriented in one or more directions (e.g., unidirectional, bidirectional, or multidirectional). The fibers may be aligned, continuous, discontinuous, and/or unidirectional.

The composite laminate can comprise, for example, continuous fibers, short fibers, pre-preg unidirectional tape, pre-preg fabric, a combination of pre-preg tape and fabric layers to create a hybrid laminate, or fabric or unidirectional fibers infused by resin and cured into a laminate. As would be understood by a PHOSITA, selection of materials and/or orientation of layers within such a composite laminate of first material 304 can be tailored to produce various coefficients of thermal expansion for thermal loading.

Second material 308 can comprise at least one metal, such as aluminum or aluminum alloy, nickel or nickel alloy, niobium or niobium alloy, magnesium or magnesium alloy, steel or steel alloy, titanium or titanium alloy, tungsten or tungsten alloy, or vanadium or vanadium alloy. As would be understood by a PHOSITA, selection of materials for second material 308 can be tailored to produce various coefficients of thermal expansion for thermal loading.

In addition, or in the alternative, second material 308 can comprise an additively manufactured metal part. Second material 308 can comprise at least one non-metal, at least one polymer, or a composite laminate. In addition, or in the alternative, second material 308 can comprise an additively manufactured polymer part.

Such a composite laminate of second material 308 can comprise reinforcing fibers, such as carbon fibers, glass fibers, or carbon fibers and glass fibers. Such fibers may have no specific orientation (e.g., omnidirectional) or may be oriented in one or more directions (e.g., unidirectional, bidirectional, or multidirectional). The fibers may be aligned, continuous, discontinuous, and/or unidirectional.

The composite laminate can comprise, for example, continuous fibers, short fibers, pre-preg unidirectional tape, pre-preg fabric, a combination of pre-preg tape and fabric layers to create a hybrid laminate, or fabric or unidirectional fibers infused by resin and cured into a laminate. As would be understood by a PHOSITA, selection of materials and/or orientation of layers within such a composite laminate of second material 308 can be tailored to produce various coefficients of thermal expansion for thermal loading.

In a first example, first material 304 can comprise at least one metal, such as nickel or nickel alloy, and second material 308 can comprise at least one polymer. In a second example, first material 304 can comprise at least one non-metal, and second material 308 can comprise an additively manufactured metal part.

Because first member 302 and third member 310 comprise first material 304, first member 302 and third member 310 have a first coefficient of thermal expansion. Because second member 306 comprises second material 308, second member 306 has a second coefficient of thermal expansion.

For analysis of combined mechanical and thermal loading of structures, it is desired that the first coefficient of thermal expansion differ from the second coefficient of thermal expansion. Under some testing conditions, the first coefficient of thermal expansion can be greater than the second coefficient of thermal expansion, while under other testing conditions, the first coefficient of thermal expansion can be less than the second coefficient of thermal expansion.

As shown in FIGS. 3A and 3C, in order to simplify calculations, estimates, measurements, and other issues associated with analysis of combined mechanical and thermal loading of structures, second member 306 can comprise a substantially flat, rectangular plate having length L₃₀₆, width W₃₀₆, and height H₃₀₆. Example values include: length L₃₀₆ (e.g., 5”-100”, 7.5”-50”, or 10”-25”—such as 6.5”, 9.5”, 10”, 11.5”, 13.5”, 14.5”, 15”, 18.5”, 20”, 23.5”, or 24.5”); width W₃₀₆ (e.g., 1”-10”, 1.5”-5”, or 2”-4”—such as 1.5”, 2”, 2.5”, or 3”); and height H₃₀₆ (e.g., 0.05”-0.60”, 0.06”-0.30”, or 0.075”-0.15”—such as 0.08”, 0.09”, 0.10”, or 0.135”).

Although other shapes could be used for second member 306, such as a plate with a circular, triangular, pentagonal, hexagonal, or other cross section (rather than a rectangular cross section) or a plate whose overall shape resembles a circle, ellipse, oval, parallelogram, rhombus, trapezoid, or other FIGURE(rather than a rectangle), a PHOSITA would recognize that such alternate cross sections and/or overall shapes could add complexity to the calculations, estimates, measurements, and other issues associated with the analysis of combined mechanical and thermal loading of structures.

As also shown in FIGS. 3A and 3C, second member 306 can define a 3D coordinate-axis system for device 300 that includes an X-axis along length L₃₀₆, a Y-axis along width W₃₀₆, and a Z-axis along height H₃₀₆ in which the positive directions for the axes follow the right-hand rule. When second member 306 is a substantially flat, rectangular, homogeneous plate, the center of mass of second member 306 should lie on the X-axis.

In order to facilitate fastening second member 306 to first member 302 and third member 310, second member 306 can include through holes 316 and 318. Through holes 316 and 318 should lie along the X-axis and the direction of through holes 316 and 318 should be parallel to the Z-axis. Although a PHOSITA would recognize that other approaches for fastening second member 306 to first member 302 and third member 310 can be used, through holes that are aligned and penetrate first member 302, second member 306, and third member 310 provide an approach that is simple, efficient, effective, and should provide repeatable testing results.

In order to simplify calculations, estimates, measurements, and other issues associated with analysis of combined mechanical and thermal loading of structures, when first member 302 and third member 310 are mechanically loaded by second member 306, the mechanical load on first member 302 from second member 306 should be equal to the mechanical load on third member 310 from second member 306, so that the net mechanical load is applied along the X-axis. Because of this net mechanical loading along the X-axis, first member 302 and third member 310 should not have a tendency to bend, curl, or twist, and should not have a tendency to move along the Y-axis, to move along the Z-axis, to roll with respect to the X-axis, to pitch with respect to the Y-axis, or to yaw with respect to the Z-axis. As shown in FIG. 3A, this paragraph applies to both ends of device 300.

As shown in FIGS. 3A and 3B, in order to simplify calculations, estimates, measurements, and other issues associated with analysis of combined mechanical and thermal loading of structures, first member 302 can comprise a substantially flat, rectangular plate having length L₃₀₂, width W₃₀₂, and height H₃₀₂. Example values include: length L₃₀₂ (e.g., 5”-100”, 7.5”-50”, or 10”-25”—such as 6.5”, 9.5”, 10”, 11.5”, 13.5”, 14.5”, 15”, 18.5”, 20”, 23.5”, or 24.5”); width W₃₀₂ (e.g., 1”-10”, 1.5”-5”, or 2”-4”—such as 1.5”, 2”, 2.5”, or 3”); and height H₃₀₂ (e.g., 0.05”-0.60”, 0.06”-0.30”, or 0.075”-0.15”—such as 0.08”, 0.09”, 0.10”, or 0.135”).

Although other shapes could be used for first member 302, such as a plate with a circular, triangular, pentagonal, hexagonal, or other cross section (rather than a rectangular cross section) or a plate whose overall shape resembles a circle, ellipse, oval, parallelogram, rhombus, trapezoid, or other FIGURE(rather than a rectangle), a PHOSITA would recognize that such alternate cross sections and/or overall shapes could add complexity to the calculations, estimates, measurements, and other issues associated with the analysis of combined mechanical and thermal loading of structures.

As shown in FIG. 3A, when assembling device 300, first member 302 can be substantially aligned with second member 306 along the X-axis.

In order to facilitate fastening second member 306 to first member 302, first member 302 can include through holes 320 and 322. When assembling device 300, through holes 320 and 322 should lie along the X-axis and the direction of through holes 320 and 322 should be parallel to the Z-axis. Although a PHOSITA would recognize that other approaches for fastening second member 306 to first member 302 can be used, through holes that are aligned and penetrate first member 302, second member 306, and third member 310 provide an approach that is simple, efficient, effective, and should provide repeatable testing results.

As shown in FIGS. 3A and 3D, in order to simplify calculations, estimates, measurements, and other issues associated with analysis of combined mechanical and thermal loading of structures, third member 310 can comprise a substantially flat, rectangular plate having length L₃₁₀, width W₃₁₀, and height H₃₁₀. Third member 310 can be, for example, thickened at one end for increased strength. Example values include: length L₃₁₀ (e.g., 5”-100”, 7.5”-50”, or 10”-25”—such as 6.5”, 9.5”, 10”, 11.5”, 13.5”, 14.5”, 15”, 18.5”, 20”, 23.5”, or 24.5”); width W₃₁₀ (e.g., 1”-10”, 1.5”-5”, or 2”-4”—such as 1.5”, 2”, 2.5”, or 3”); and height H₃₁₀ (e.g., 0.05”-0.60”, 0.06”-0.30”, or 0.075”-0.15”—such as 0.08”, 0.09”, 0.10”, or 0.135”).

Although other shapes could be used for third member 310, such as a plate with a circular, triangular, pentagonal, hexagonal, or other cross section (rather than a rectangular cross section) or a plate whose overall shape resembles a circle, ellipse, oval, parallelogram, rhombus, trapezoid, or other FIGURE(rather than a rectangle), a PHOSITA would recognize that such alternate cross sections and/or overall shapes could add complexity to the calculations, estimates, measurements, and other issues associated with the analysis of combined mechanical and thermal loading of structures.

As shown in FIG. 3A, when assembling device 300, third member 310 can be substantially aligned with second member 306 along the X-axis.

In order to facilitate fastening second member 306 to third member 310, third member 310 can include through holes 326 and 328. When assembling device 300, through holes 326 and 328 should lie along the X-axis and the direction of through holes 326 and 328 should be parallel to the Z-axis. Although a PHOSITA would recognize that other approaches for fastening second member 306 to third member 310 can be used, through holes that are aligned and penetrate first member 302, second member 306, and third member 310 provide an approach that is simple, efficient, effective, and should provide repeatable testing results.

When first member 302 and third member 310 are mechanically loaded by second member 306, a distance in the X-axis direction between fasteners joining first member 302 and third member 310 to second member 306 can increase.

Device 300 can be configured to apply force to both ends of second member 306 (e.g., a first protruding end of second member 306 and a second protruding end of second member 306). A first load path is through the first protruding end of second member 306 (e.g., clamped or fastened to a universal testing machine), through second member 306, and to the second protruding end of second member 306 (e.g., also clamped or fastened to the universal testing machine). A second load path is through the first protruding end of second member 306 (e.g., clamped or fastened to the universal testing machine), through a first fastener in through hole 322 in first member 302 and through hole 318 in second member 306, through first member 302, through a second fastener in through hole 320 in first member 302 and through hole 316 in second member 306, and to the second protruding end of second member 306 (e.g., also clamped or fastened to the universal testing machine). A third load path is through the first protruding end of second member 306 (e.g., clamped or fastened to the universal testing machine), through the first fastener in through hole 328 in third member 310 and through hole 318 in second member 306, through third member 310, through the second fastener in through hole 326 in third member 310 and through hole 316 in second member 306, and to the second protruding end of second member 306 (e.g., also clamped or fastened to the universal testing machine).

As discussed above, first member 302 can comprise a first plate, second member 306 can comprise a second plate, and third member 310 can comprise a third plate. One or more plates of the first, second, and third plates can comprise a substantially flat, rectangular plate. As discussed above, a PHOSITA would recognize that alternate cross sections and/or overall shapes, although useable, could add complexity to the calculations, estimates, measurements, and other issues associated with the analysis of combined mechanical and thermal loading of structures.

The first and third plates can lie in parallel geometric planes. The first, second, and third plates can lie in parallel geometric planes.

As shown in FIGS. 1A, 1B, 1C and 1D, device 100 can comprise a double-pin thermal-mechanical (“DPTM”) test joint; as shown in FIGS. 2A, 2B and 2C, device 200 can comprise a DPTM test joint; and as shown in FIGS. 3A, 3B, 3C and 3D, device 300 can comprise a DPTM test joint.

By careful selection of physical parameters, DPTM test joint 100, 200, 300 can emulate or replicate actual structures used, for example, in the construction of aircraft. For example, first member 102, second member 106, and third member 110 can emulate or replicate an actual structure to be used in a particular aircraft, incorporating for the respective members the same materials, the same dimensions, the same relative locations, the same fasteners (e.g., the same fastener diameters) (e.g., ¼” or ½” diameter Inconel fasteners), the same fastener-to-fastener spacing (e.g., 1”-60”, 2”-30”, or 5”-15”—such as 5”, 10”, 15”, 25”, or 50”), etc.

In DPTM test joint 100, for example, if first member 102 and third member 110 are aluminum plates and second member 106 is a composite laminate, then under cold-loading conditions, first member 102 and third member 110 will attempt to contract equally due to their matching, relatively high values for the coefficient of thermal expansion (“CTE”), while second member 106 will attempt to contract less due to its relatively low value for CTE. The fasteners used to join first member 102 to second member 106 and third member 110 to second member 106 will then constrain the contraction, putting first member 102 and third member 110 in tension, while putting second member 106 in compression. Adding mechanical tension load to the joint increases the tensile load in first member 102 and in third member 110, and if the tensile load becomes too high, DPTM test joint 100 is designed to fail across the fastener region in either first member 102 or third member 110. As would be understood by a PHOSITA, the initial thermal load can be measured during testing or can be found using theory.

DPTM test joint 100, 200, 300 can be gripped, loaded, and tested using standard testing machines known to a PHOSITA, such as High Force Universal Testing Machines made by Instron.^{®} For testing at stable, non-ambient temperatures, the desired temperature (e.g., -100° F to +100° F, -80° F to +80° F, or -70° F to +70° F —such as -65° F or +70° F) can be imposed directly to one or more portions of DPTM test joint 100, 200, 300 (e.g., directly to first member 102, second member 106, and/or third member 110). In a first alternative, a testing machine can be equipped with a furnace configured to achieve stable, non-ambient temperatures. In a second alternative, the testing machine can be located in a chamber in which DPTM test joint 100, 200, 300 can be subjected to stable, non-ambient temperatures. In a third alternative, DPTM test joint 100, 200, 300 can be heated or cooled to a stable, non-ambient temperature prior to installing DPTM test joint 100, 200, 300 into the testing machine.

At least one physical parameter of DPTM test joint 100, 200, 300 (e.g., first member 102 and/or third member 110) related to stress analysis can be incorporated into DPTM test joint 100, 200, 300 (e.g., height, length, and width of respective members) or measured (e.g., temperature of respective members, failure load). Such physical parameters can include, for example, height, length, and width; fastener diameter; fastener-to-fastener spacing; load; relative location of respective members; strain; and temperature.

As would be understood by a PHOSITA, high quality testing machines typically include measurement devices. Other measurement devices that can be used include, for example, extensometers (contact or non-contact), infrared sensors, lasers, load cells, piezoelectric sensors, resistive temperature devices (“RTDs”), strain gages, thermistors, and thermocouples.

Material tests using DPTM test joint 100, 200, 300 demonstrate that thermally induced stresses are secondary stresses which are relieved as the member undergoes plastic strain. Therefore, prior to ultimate failure, the majority of thermally induced stresses has dissipated and the ultimate load of a thermal-mechanically loaded specimen is approximately equal to that of the same specimen under only mechanical loading. This realization enables a method to correct the predictions of simplified analyses (e.g., linear elastic full-vehicle FEAs) used for structural sizing by considerably reducing the consideration of thermal loads, allowing for new designs to potentially avoid taking a “weight penalty” associated with overestimating the influence of thermal loads on the full vehicle.

DPTM test joint 100, 200, 300 and associated methods enable capturing improved accuracy of thermal loads directly from the full-vehicle FEAs without increasing model complexity (e.g., the DPTM test joint and associated methods provide numerical evidence of what percentage of the thermally induced stress should be dissipated as a member deforms plastically up until ultimate failure). Engineers can implement corrections to the thermally induced loads for the given material system and geometry to obtain an improved estimate of the combined mechanical and thermal loading. This enables improved methods in the design and analysis phases for vehicles and is robust enough to be readily applied to given design changes without excessive re-work or additional person-hours to develop models.

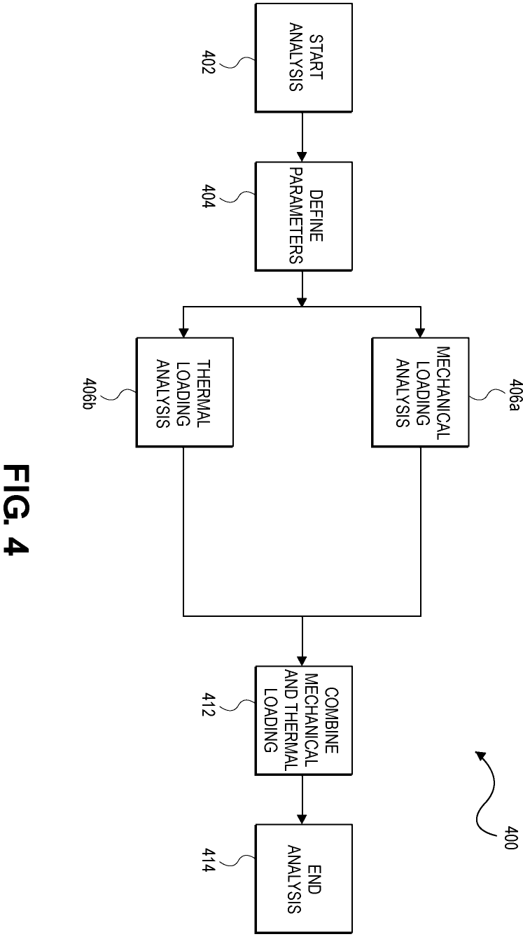

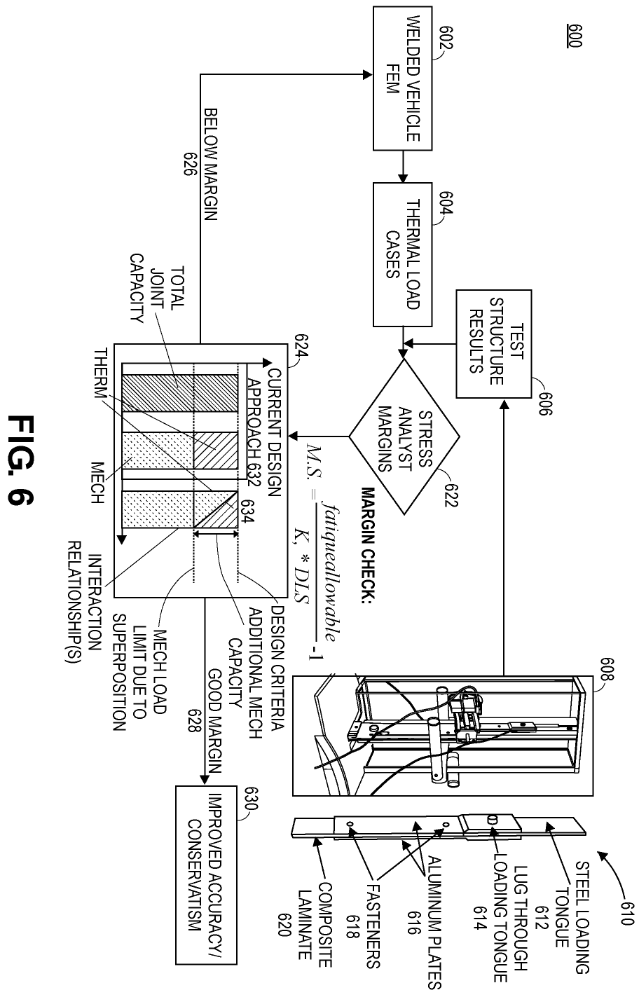

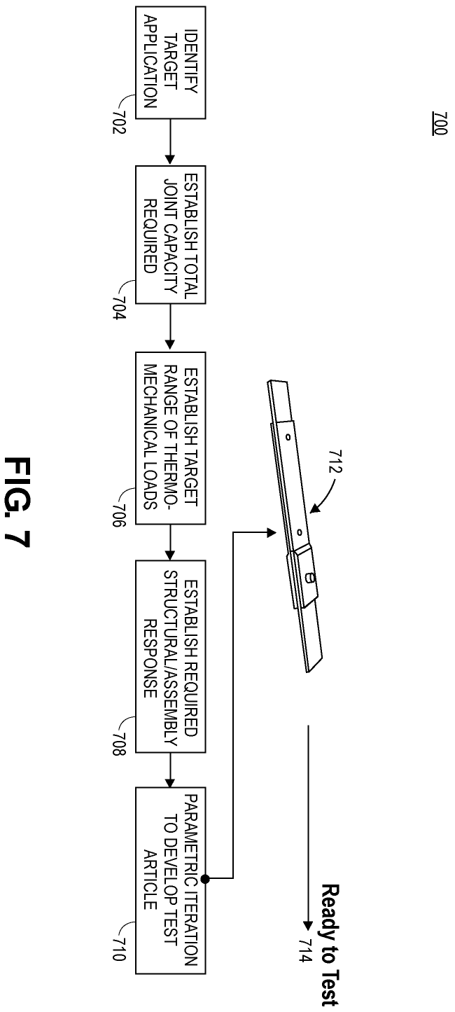

FIG. 4 shows a method (400) for analysis of (e.g., determining failure loads for) mechanical and thermal loading of structures. The method of FIG. 4 can be used as a basis for the method of FIG. 6 and FIG. 7, as discussed further below.

In FIG. 4, an engineer starts an analysis (402) for the combined mechanical and thermal loading for a full vehicle. Initially, the engineer defines parameters associated with the vehicle (404). Such parameters can include, for example, the configuration of the vehicle, the amount of mechanical loading, and the amount of thermal loading. The engineer then performs a simplified mechanical loading analysis (406a) for the full vehicle, as would be understood by a PHOSITA, and additionally performs a simplified thermal loading analysis (406b) for the full vehicle, as also would be understood by a PHOSITA. Finally, the engineer determines the loading of the vehicle at failure by combining the thermal loading with a proportionally scaled mechanical loading (412) (e.g., combining the results of the thermal loading analysis with a scaled mechanical loading that is increased proportionally until the failure load of a member is reached). This failure load is then compared to the ultimate design load to determine the ultimate margin of safety. If the ultimate margin of safety is either too high or too low, the engineer can make changes to improve the design (e.g., ensuring failure will not occur while minimizing weight, cost, etc.). That would conclude the engineer’s analysis (414) for the combined mechanical and thermal loading of the full vehicle.

Because thermal loading is inherently self-limiting, the predicted failure load is necessarily more conservative than the true failure load. Such conservative predictions of failure load effectively require more robust structures, which tends to increase the weight of those structures, resulting in an associated “weight penalty.”

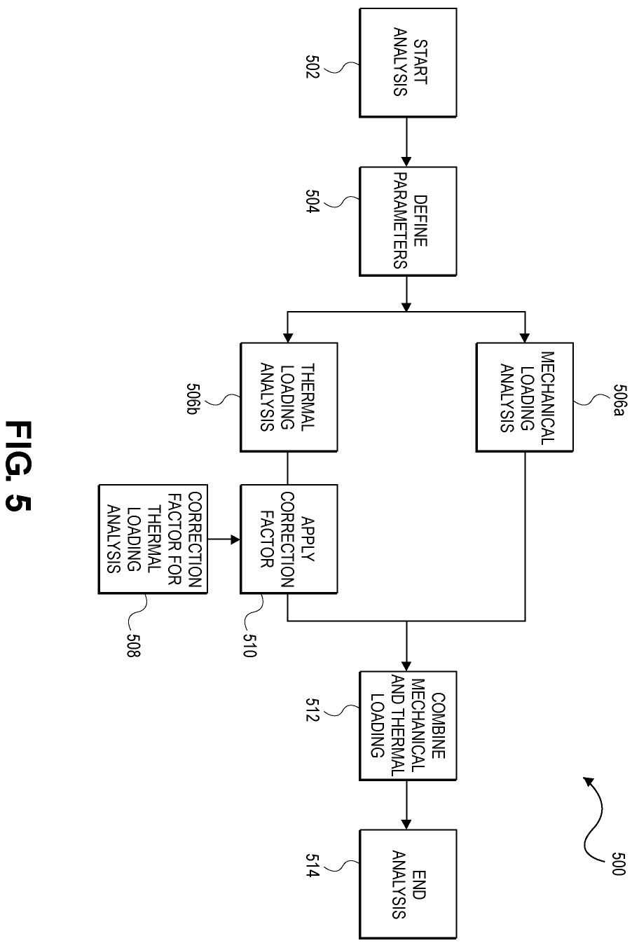

FIG. 5 shows an improved method (500) for analysis of (e.g., determining failure loads for) mechanical and thermal loading of structures.

In FIG. 5, an engineer starts an analysis (502) for the combined mechanical and thermal loading for a full vehicle. Initially, the engineer defines parameters associated with the vehicle (504). Such parameters can include, for example, the configuration of the vehicle, the amount of mechanical loading, and the amount of thermal loading. The engineer then performs a simplified mechanical loading analysis (506a) for the full vehicle, as would be understood by a PHOSITA, and additionally performs a simplified thermal loading analysis (506b) for the full vehicle, as also would be understood by a PHOSITA. Next, the engineer applies a correction factor (510) to the simplified thermal loading analysis based on appropriate DPTM testing (508) to estimate an improved thermal loading. Finally, the engineer determines the loading of the vehicle at failure by combining the improved thermal loading with a proportionally scaled mechanical loading (512) (e.g., combining the results of the corrected thermal loading analysis with a scaled mechanical loading that is increased proportionally until the failure load of a member is reached). This failure load is then compared to the ultimate design load to determine the ultimate margin of safety. If the ultimate margin of safety is either too high or too low, the engineer can make changes to improve the design (e.g., ensuring failure will not occur while minimizing weight, cost, etc.). That would conclude the engineer’s analysis (514) for the combined mechanical and thermal loading of the full vehicle.

Because the simplified thermal loading analysis is modified based on DPTM testing, the predicted failure load in the method (500) of FIG. 5 can be much higher than in the method (400) of FIG. 4, allowing less conservatism in the design of structures, which tends to decrease the weight of those structures, reducing or eliminating the associated “weight penalty.”

As discussed above, high thermally induced stresses exist in multi-material structural joints and assemblies. They are a result of fastened joints/members of dissimilar materials (e.g. metallic and composite laminates) for which the members expand/contract at different rates under hot/cold temperatures due to different material-dependent coefficients of thermal expansion (CTEs), but such deformation is restrained by fasteners mechanically joining the members; thus, putting the members in tension or compression. While it is rare to observe failure due to thermally induced stresses alone, in combination with mechanical loads these members may fail in the metallic component (undesirable), particularly at cold temperatures that place the metallic in tension prior to mechanical loading. In these situations, the metal will undergo plastic strain prior to failure. A test article ‘double pin thermal-mechanical joint’ is discussed above to provide data by which engineering teams may evaluate and validate joint design. As discussed below, examples of the present disclosure can provide for methods of how the joint can be designed and one or more requirements for how the joint should behave in order to provide accurate data, the test and inspection methodology to characterize the double pin thermal-mechanical joint behavior and quantify the results, and methods for how to use the thermal-mechanical load test data results to enable design decisions.

The conventional practice is to evaluate the global vehicle FEM under several load cases, including the estimated mechanical and thermal loading conditions expected in the environment(s) of use. The stress analyst then develops a load envelope used for sizing the structural components, which treats the mechanical and thermal loads additively in cases where additional stress results from the thermal cases. Prescribed safety factors are applied and the structural component is sized/designed to satisfy these load requirements. However, the inclusion of the full initial thermal load is shown to be excessively conservative due to dissipation of secondary stresses as the member undergoes plastic strain. Additional load relief mechanisms can include: geometric tolerance change due to hole expansion/contraction in the presence of thermal load, loss of clamp-up force (torque reduction) in the associated bolt connection, bending and/or deformation of the bolt pin, hole expansion/contraction due-to mechanical and combined thermal-mechanical loads, or general load capacitance within the bolt/fastener hardware stack (bolt, nut, washer, similar).

The conventional approach requires careful consideration to reduce the number of thermal-mechanical loads perturbations/cases to the limits of available schedule and funding. This is typically much lower than desired for early-phase design, which results in significant downstream negative impact on the structural weight and overall vehicle performance.

In accordance with examples of the present disclosure, the present methods and systems enables capturing improved accuracy of thermal loads directly from the standard vehicle FEMs without increasing model complexity. Instead of performing a large number of separate mechanical and thermal analyses in series, the present disclosure provides for the ability to implement corrections for the given material systems to be joined, which enables improved methods in the design and analysis phase for a vehicle and is robust enough to be readily applied given design changes without excessive re-work or additional persons-hours to develop models. This present disclosure can lead to reduced vehicle weight by reducing the excessive conservatism built into the current standard practice for structural sizing due to ultimate loads under thermal-mechanical conditions.

The DPTM is useful for determining the extent to which thermal loads may be discounted under ultimate sizing. Since failure stress, material stiffness, joint stiffness, hole elongation, and any other pertinent structurally relevant material and/or assembly behavior are design parameters, the combination of loads that cause the material to reach that stress is a useful quantity to be understood. For a given fastener-to-fastener spacing, materials joined, and thermal conditions, the DPTM provides numerical evidence of what percent of the initial thermal load is expected to be dissipated as the failing member deforms plastically up until ultimate failure. The DPTM is strategically designed to capture a wide joint configuration design space, drastically reducing the required validation testing which is currently performed.

The design of the DPTM can be altered for relevant materials in a build to develop corrections to the thermal load used in ultimate structural sizing analyses. According to examples of the present disclosure, the present systems and methods can correct these loads and find the mechanical bearing utilization and total utilization in order to find the corrected utilization. Furthermore, the DPTM is modifiable to specific fastener-to-fastener distances relevant to a specific vehicle layout. The present systems and methods uses the DPTM results to directly improve the accuracy of loads used for sizing that has direct effect on vehicle weight.

In some examples, the present systems and methods provide for obtaining the correction coefficient and applying them, performing associated data analysis, transitioning from a purely empirical/semi-empirical method to a predictive method, using DPTM knock-downs to improve welded FEM values, and a decision process using the above feature in the design process.

In some examples, the systems and methods provide for how to obtain the correction coefficients and how to apply them based on one or more of the following features: predicted failure loads, relevant pin bearing and bulk material critical loads based on joint materials, geometry, etc. and estimated pin utilization, predicted superposition loading, delta to actual total utilization of ‘1.’ In some examples, the system and method provide for how to perform the associated data analysis based on one or more of the following features: establish a correction factor based on the above features and plot the above data for multiple fastener spacings, thermal conditions, etc. The disclosed systems and method allows for a transition from a purely empirical/semi-empirical method to a predictive method (use of data) by developing curve fit to a data plot. In some examples, the systems and methods provide for the use of DPTM knock-downs to improve welded FEM values by extracting knock-down coefficients from curve fits and use in FEM (e.g. stiffness coefficients).

In some examples, the present systems and methods provides for performing the testing that achieves the relevant combination of mechanical and thermal loading at the target structure features, which can include one or more of the following: multiple specimen gage lengths, multiple fastener spacings, and multiple temperatures, such as from -100F to 200F. In some examples, the present systems and methods provides for an instrument to test articles to enable a reconfigurable fixture that allows changing fastener-to-fastener spacing and improve repeatability/quality using extensometers, clip gages, strain gages, or combinations thereof. In some examples, the present systems and methods provide the ability to characterize the thermal loads experienced by a test article or structure and compute results by recording of load-displacement based on thermal-mechanical loading, recording of thermal load contribution as a function of overall total load for all thermal conditions tested, and repeating the recordings for multiple gage lengths and fastener spacings (and/or other pertinent design features). In some examples, the present systems and methods provide for quantifying the effects of material plasticity on thermal stresses by evaluating contribution of thermal loads as a function of total joint capacity, evaluating all deformation and failure modes associated with target joint design and design requirements, filtering to conditions wherein performance requirements were met, and tabulating results to identify percentages of thermal load remaining at failure.

FIG. 6 shows a method 600 for designing large domain of joint configurations/conditions to achieve target ratios of thermal and mechanical loading according to examples of the present disclosure. The method 600 can use one or more of processes described above in FIG. 5. The method 600 begins by providing a welded vehicle FEM, which is a theoretical model of test structure 610, at 602. The welded vehicle FEM is then provided to a thermal load analysis module to conduct a thermal analysis of the welded vehicle FEM using a parametric design process, as discussed above, for example at 506b, at 604. Test structure 610, such as the test joint as discussed above, is provided to a test apparatus 608, which is a physical structure representative of the welded vehicle FEM to perform a mechanical loading analysis, as discussed above, for example at 506a. The mechanical loading analysis and the thermal loading analysis can be performed consequentially or sequentially. The test structure 610 can comprise steel loading tongue 612 that is coupled with aluminum plates 616 and a composite laminate 620 through a lug through a loading tongue 614 and fasteners 618.

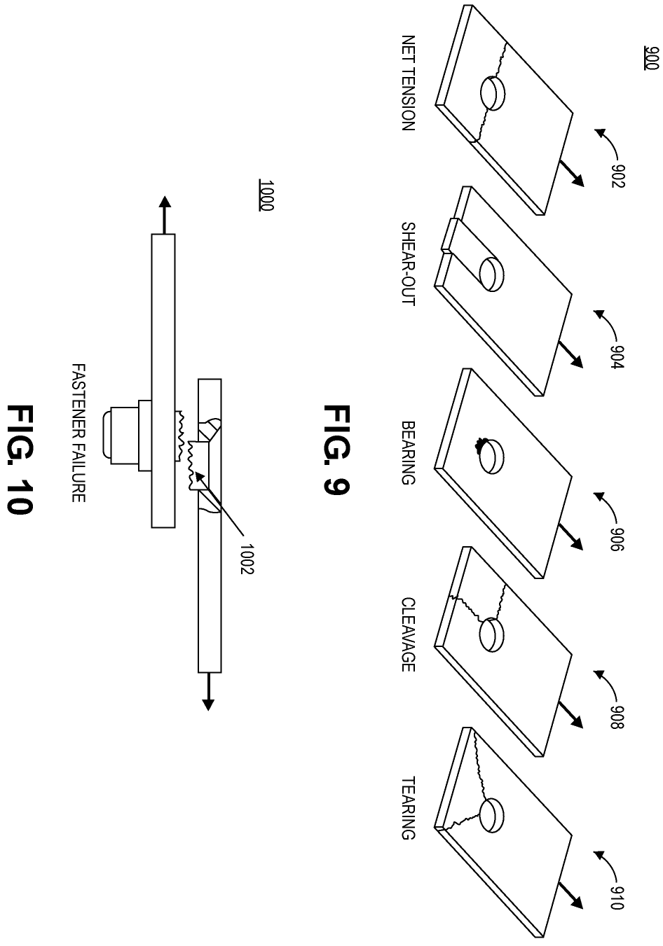

The parametric design process can involve one or more of the following attributes: 1. Material selection; 2. Determination of appropriate material behaviors (linear/elastic, nonlinear-elastic, elasto-plastic, etc.); 3. Determination of required failure modes in the bulk material(s) and pins/hardware; 4. Ability to determine correct bulk geometric features such as individual component width, thickness, and length; 5. Ability to determine correct feature geometric features such as fastener diameter, fastener spacing, torque/clamp-up force, material type, etc.; and 6. Application of relevant design requirements based on limit load, ultimate load, stiffness, hole elongation, clamp-up force/torque reduction, pin bending, hole bearing, and pin shear to iterate design. The outcome of the parametric design process is this ability to design large domain of joint configurations/conditions to achieve target ratios of thermal and mechanical loading. In some examples, the parametric design process can involve one or more of the following attributes: material selection, which can include a material of each ligament and a material of a fastener/pin and the materials of the hardware stack; and determination of appropriate material behaviors (linear/elastic, nonlinear-elastic, elasto-plastic, etc.), which can include stiffness (bulk material and joint/assembly level) and recoverable and/or non-recoverable. In some examples, the parametric design process can involve one or more of the follow attributes: 1. Determination of required failure modes in the bulk material(s) and pins/hardware, including one or more of the following: gross section ligament failure, net section failure at the hole, hole elongation, bearing, cleavage, tearing, hole shear-out, pin bending, pin shear, which are shown in FIG. 9; 2. Margin checks are run against each of these failure modes; and 3. Design is iteratively updated to ensure that each of the above parameters (failure modes) do not exceed a design criteria. In some examples, the parametric design process can involve one or more of the following attributes: 1. Ability to determine correct bulk geometric features such as individual component width, thickness, and length of all components; 2. Ability to determine correct feature geometric features such as fastener diameter, fastener spacing, torque/clamp-up force, which affect the amount of thermal stress built up in the specimen; 3. Includes all varieties of fasteners, fastener materials, and hole type (through-hole, countersunk, etc.); and 4. Application of relevant design requirements based on limit load, ultimate load, stiffness change, hole elongation, clamp-up force/torque reduction, pin bending, hole bearing, and pin shear to iterate design.

Results of the thermal analysis of the welded vehicle FEM of 604, such as in 506b, and results of the mechanical loading of test structure 606, such as in 506a, which can include the one or more coefficient corrections, as described above, are provided to an analysis module where stress analysts margins are determined at 622. The predetermined threshold for the stress analysis margins can be based on any of the aforementioned criteria, for example, in the form of a critical load level (e.g. design limit load), stress level, stiffness change, percentage of hole elongation, strain level, etc. Results from the stress analysis module as determined at 622 are provided at 624, which shows example plots of comparing conventional design approaches 632 to design criteria according to examples of the present disclosure 634. The design criteria according to examples of the present disclosure shows contributions of the thermal portion and the mechanical portion of the total joint capacity and possible overlap contributions between the two. If the results of the stress analysis module determines that the margins are below a predetermined criteria, as shown as below margin 626, the method 600 proceeds back to 602 and if the results of the stress analysis module determines that the margins are acceptable, as shown as good margin 628, the method 600 proceeds to 630 where the improved accuracy/conservatism results are outputted where the conservatism may be reduced or better understood that a more accurate margin has be characterized.

FIG. 7 shows a method 700 for preparing the test structure for testing according to examples of the present disclosure. The method 700 begins by identifying a target application that the test structure is intended to be used, as in 702. The method 700 continues by establishing total joint capacity required for the test structure in the target application, as in 704. The method 700 continues by establishing a target range of thermal-mechanical loads that the test structure may be subjected to during the target application, as in 706. The method 700 continues by establishing a required structure/assembly response for the test structure during the target application, as in 708. The method 700 continues by performing a parametric iteration to develop the test structure, as in 710, using one or more of the attributes discussed above. The method 700 continues by developing the test structure, as in 712. The method 700 continues by preparing the test structure for testing, as in 714. The method 700 yields a design of a joint which achieves a target ratio (or range of ratios) of thermal and mechanical loading based on a variety of potential failure modes within the joint materials and overall assembly.

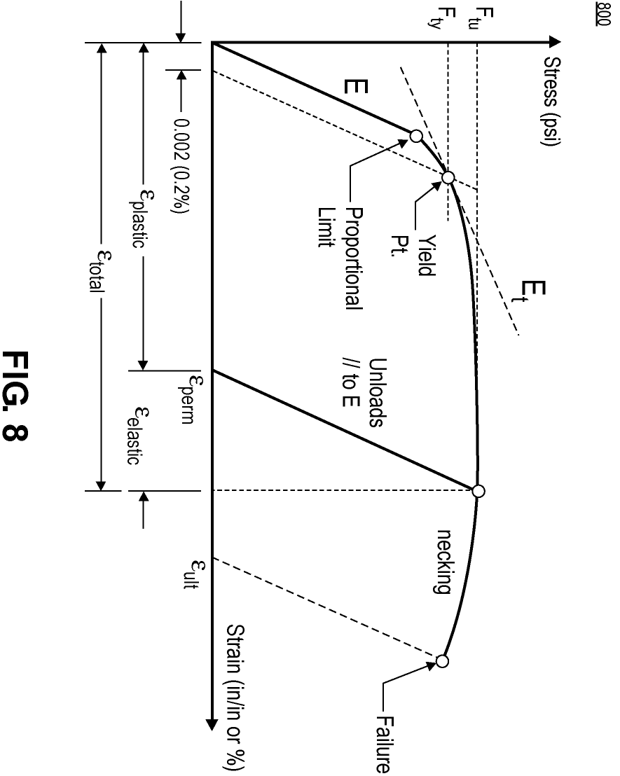

FIG. 8 shows a plot 800 of stress versus strain as provided by the analysis module for a test structure according to examples of the present disclosure. As noted in the plot 800, the proportional limit, the yield point, a necking region, and a failure point are shown for the test structure.

FIG. 9 shows a series failure modes 900 that can be experienced by the test structures according to examples of the present disclosure. The test structure can experience net tension, as shown in 902, shear-out, as shown in 904, bearing deformation, as shown in 906, cleavage deformation, as shown in 908, and tearing, as shown in 910.

FIG. 10 shows test structure 1000 where a fastener 1002 has failed due to a shear force, bending, or pull-out experienced by components of the test structure, according to examples of the present disclosure.

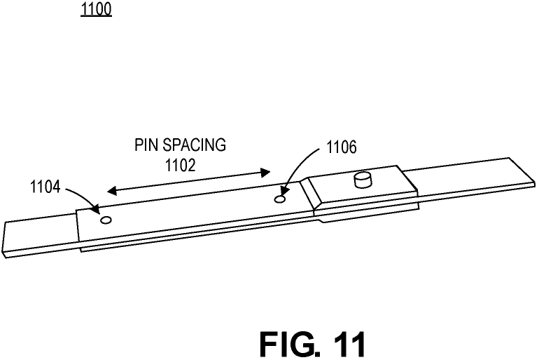

FIG. 11 shows test structure 1100 with pin spacing 1102 identified between two fastener locations 1104 and 1106, which can be used during the analysis performed by the analysis module, according to examples of the present disclosure.

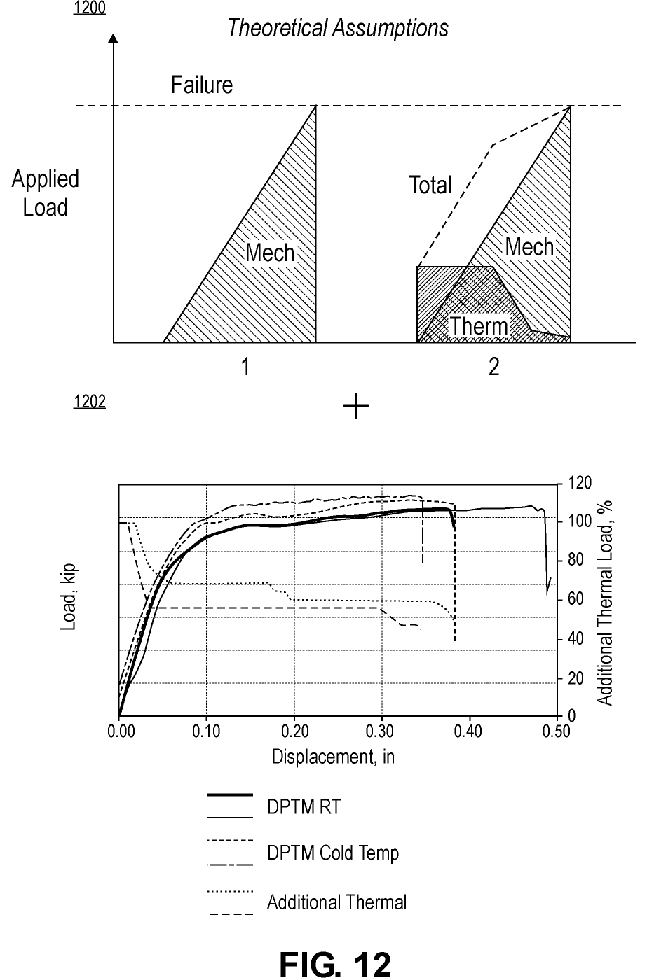

FIG. 12 shows a plot of theoretical assumptions 1200 and physical test and inspection data 1202, which can be used during the analysis performed by the analysis module, according to examples of the present disclosure.

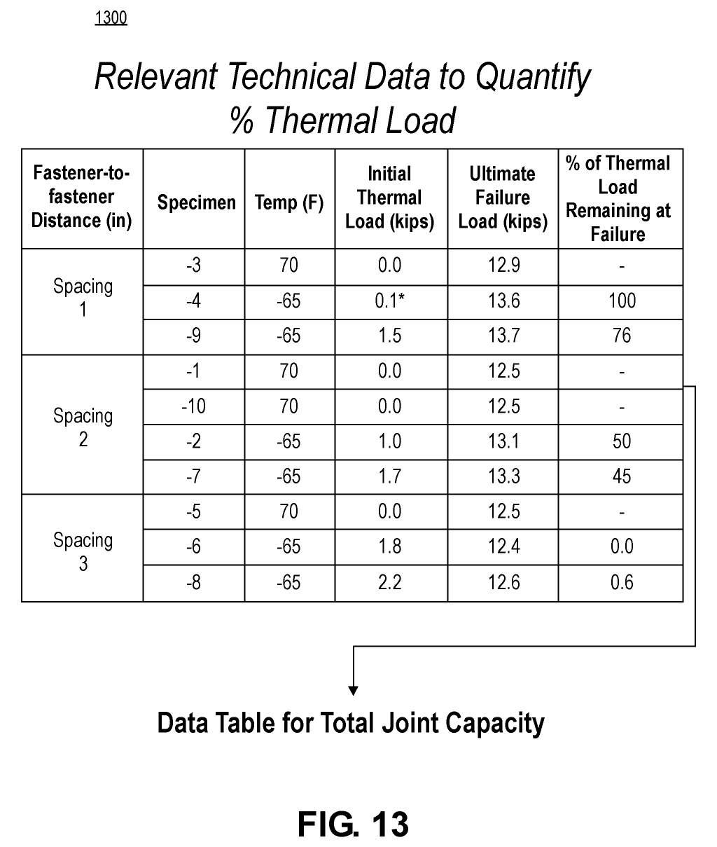

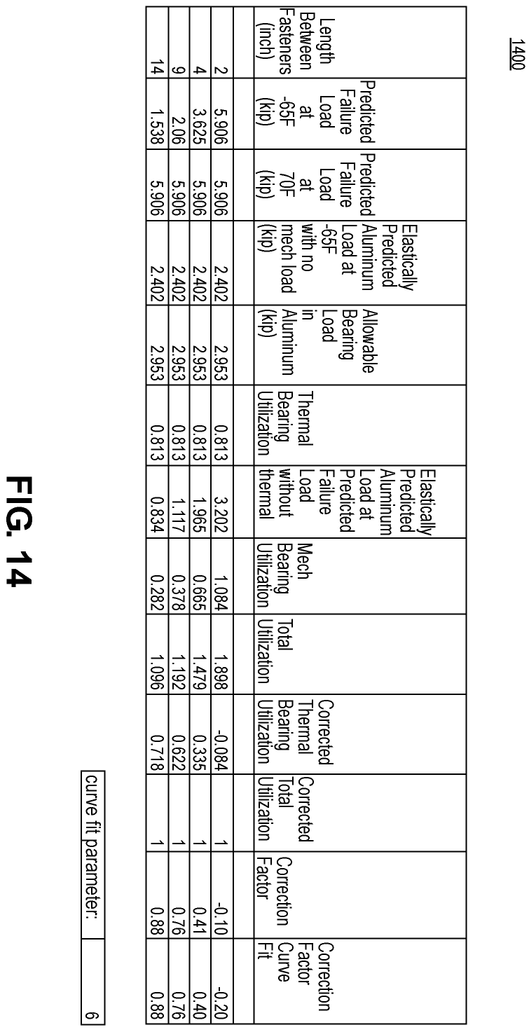

FIG. 13 shows a table 1300 showing relevant technical data based on any of the pertinent parametric aspects of the joint design (e.g., hole diameters, material thickness, fastener spacing, clamp-up level of the joint hardware, etc. ) to quantify the percentage of thermal load for the test structure with different fastener-to-fastener distances, according to examples of the present disclosure.

FIG. 14 shows a table 1400 of various results that can be produced by the analysis module for a variety of lengths between fasteners for a test structure, according to examples of the present disclosure.

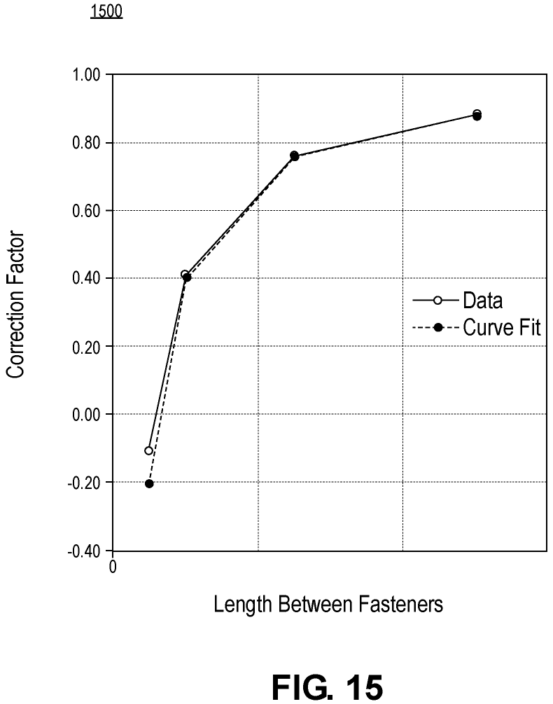

FIG. 15 shows a plot 1500 of a correction factor verses length between fasteners based on any of the above-noted pertinent parametric parameters comparing data from the analysis module with curved fitted data according to examples of the present disclosure.

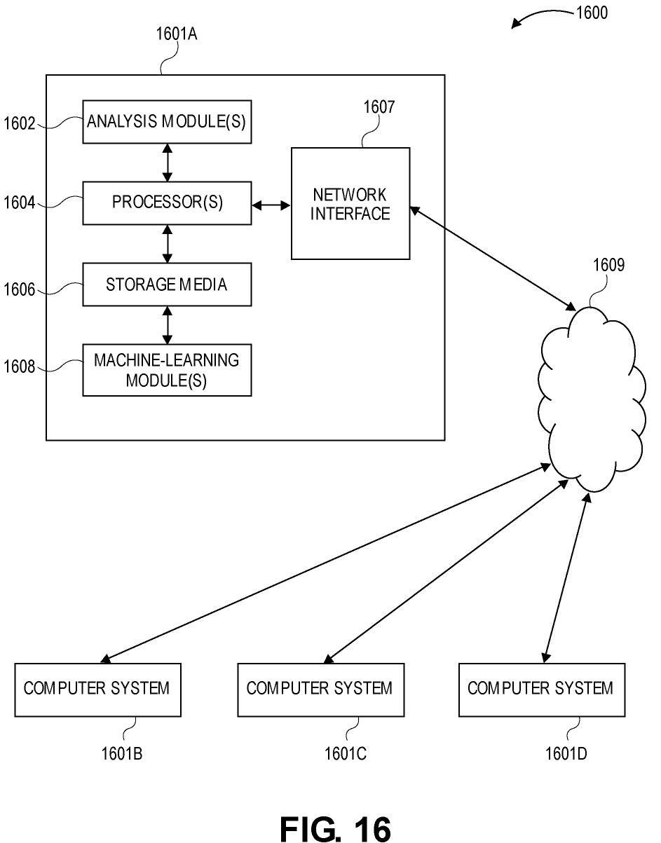

In some examples, any of the methods of the present disclosure may be executed by a computing system. FIG. 16 illustrates an example of such a computing system 1600, in accordance with some examples. The computing system 1600 may include a computer or computer system 1601A, which may be an individual computer system 1601A or an arrangement of distributed computer systems. The computer system 1601A includes one or more analysis module(s) 1602 configured to perform various tasks according to some embodiments, such as one or more methods disclosed herein. To perform these various tasks, the analysis module 1602 executes independently, or in coordination with, one or more processors 1604, which is (or are) connected to one or more storage media 1606. The processor(s) 1604 is (or are) also connected to a network interface 1607 to allow the computer system 1601A to communicate over a data or communications network 1609 with one or more additional computer systems and/or computing systems, such as 1601B, 1601C, and/or 1601D (note that computer systems 1601B, 1601C and/or 1601D may or may not share the same architecture as computer system 1601A, and may be located in different physical locations, e.g., computer systems 1601A and 1601B may be located in a processing facility, while in communication with one or more computer systems such as 1601C and/or 1601D that are located in one or more data centers, and/or located in varying countries on different continents). A processor can include a microprocessor, microcontroller, processor module or subsystem, programmable integrated circuit, programmable gate array, or another control or computing device.

The storage media 1606 can be implemented as one or more computer-readable or machine-readable storage media. The storage media 1606 can be connected to or coupled with a machine learning module(s) 1608, including one or more deep learning neural networks. Note that while in the example embodiment of FIG. 16 storage media 1606 is depicted as within computer system 1601A, in some embodiments, storage media 1606 may be distributed within and/or across multiple internal and/or external enclosures of computing system 1601A and/or additional computing systems. Storage media 1606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY^{®} disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions or located at a remote site from which machine-readable instructions can be downloaded over a network for execution.

It should be appreciated that computing system 1600 is only one example of a computing system, and that computing system 1600 may have more or fewer components than shown, may combine additional components not depicted in the example embodiment of FIG. 16, and/or computing system 1600 may have a different configuration or arrangement of the components depicted in FIG. 16. The various components shown in FIG. 16 may be implemented in hardware, software, or a combination of both hardware and software, including one or more signal processing and/or application specific integrated circuits.

Further, the steps in the processing methods described herein may be implemented by running one or more functional modules in an information processing apparatus such as general purpose processors or application specific chips, such as ASICs, FPGAs, PLDs, or other appropriate devices. These modules, combinations of these modules, and/or their combination with general hardware are all included within the scope of protection of the invention.

The various above-described factors, models and/or other interpretation aids may be refined in an iterative fashion; this concept is applicable to embodiments of the present methods discussed herein. This can include use of feedback loops executed on an algorithmic basis, such as at a computing device (e.g., computing system 1600, FIG. 16), and/or through manual control by a user who may make determinations regarding whether a given step, action, template, model, or set of curves has become sufficiently accurate for the evaluation of the signal(s) under consideration.

Examples of the present disclosure can further be described by one or more of the following clauses:

Clause 1. A method for analysis of mechanical and thermal loading of a double-pin thermal-mechanical structure, the method comprising:

obtaining a first plurality of parameters of a test physical double-pin thermal-mechanical structure;

obtaining a second plurality of parameters of a finite element model representative of the test physical double-pin thermal-mechanical structure;

performing a thermal load test on the finite element model representative of the test physical double-pin thermal-mechanical structure over the first plurality of parameters, the second plurality of parameters, and over a range of operating temperatures that the test physical double-pin thermal-mechanical structure is expected to experience;

performing, concurrently or separately to the thermal load test, a mechanical stress test on the finite element model representative of the test physical double-pin thermal-mechanical structure over the plurality of parameters and over a range of operating temperatures that the test physical double-pin thermal-mechanical structure is expected to experience;

determining that the thermal load test and the mechanical stress test meet a predetermined threshold; and

designing the test physical double-pin thermal-mechanical structure based on the determining that the thermal load test and the mechanical stress test meet a predetermined threshold.

Clause 2. The method of clause 1, further comprising generating one or more coefficients that adjust the finite element model to represent the test physical double-pin thermal-mechanical structure under operating conditions.

Clause 3. The method of clause 1 or clause 2, further comprising generating a stress versus strain curve for each of the first parameters of the test physical double-pin thermal-mechanical over the range of operating temperatures.

Clause 4. The method of any of clauses 1-3, wherein the first plurality of parameters and the second plurality of parameters comprise one or more of: a fastener-to-fastener spacing, properties of materials that constitute the test physical double-pin thermal-mechanical structure, material behaviors of the materials that constitute the test physical double-pin thermal-mechanical structure, failure modes of the materials that constitute the test physical double-pin thermal-mechanical structure, bulk geometric features of the materials that constitute the test physical double-pin thermal-mechanical structure, application of the test physical double-pin thermal-mechanical structure, and combinations thereof.

Clause 5. The method of any of clauses 1-4, wherein the double-pin thermal-mechanical structure comprises:

a first member comprising first material;

a second member comprising second material; and

a third member comprising the first material;

wherein the second member is at least partially between the first member and the third member,

wherein the second member is fastened to the first member and the third member,

wherein the first material differs from the second material, and

wherein the mechanical stress test is configured to mechanically load the first member, the second member, and the third member by applying equal and opposite force to protruding ends of the first member, the second member, and the third member.

Clause 6. The method of any of clauses 1-5, wherein the double-pin thermal-mechanical structure comprises:

a first member comprising a first member protruding end and a first member non-protruding end and comprising first material;

a second member comprising a second member protruding end and a second member non-protruding end and comprising second material; and

a third member comprising a third member protruding end and a third member non-protruding end and comprising the first material;

wherein the second member is at least partially between the first member and the third member,

wherein the second member is fastened to the first member and the third member by a fastener secured through a first member through hole and a third member through hole,

wherein the first material differs from the second material, and

wherein the mechanical stress test is configured to mechanically load the first member, the second member, and the third member by applying equal and opposite force to the first member protruding end, the second member protruding end, and the third member protruding end.

Clause 7. The method of any of clauses 1-6, wherein the first material has a first coefficient of thermal expansion,

wherein the second material has a second coefficient of thermal expansion, and

wherein the first coefficient of thermal expansion differs from the second coefficient of thermal expansion.

Clause 8. The method of any of clauses 1-7, wherein the first coefficient of thermal expansion is greater than the second coefficient of thermal expansion or the first coefficient of thermal expansion is less than the second coefficient of thermal expansion.

Clause 9. The method of any of clauses 1-8, wherein the first material comprises at least one metal, at least one non-metal, or a composite laminate.

Clause 10. The method of any of clauses 1-9, wherein the second material comprises at least one metal, at least one non-metal, or at least one composite laminate.

Clause 11. A method for analysis of mechanical and thermal loading of structures, the method comprising:

constructing a test physical double-pin thermal-mechanical structure by fastening a second member to a first member and a third member to form a device for the analysis, wherein the second member is at least partially between the first member and the third member;

thermally loading the device by raising or lowering a temperature of the first, second, and third members;

mechanically loading the device by applying equal and opposite force to protruding ends of the first member, the second member, and the third member; and

measuring a failure load or other relevant physical parameter of the device.

Clause 12. The method of clause 11, further comprising:

determining one or more coefficient corrections for a thermal loading analysis based on the failure load or other relevant physical parameters of the device that are measured.

Clause 13. The method of clause 11 or clause 12, further comprising:

determining one or more coefficient corrections for a combined mechanical and thermal loading analysis based on the failure load or other relevant physical parameters of the device that are measured.

Clause 14. The method of any of clauses 11-13, wherein the test physical double-pin thermal-mechanical structure comprises a first material that has a first coefficient of thermal expansion and a second material that has a second coefficient of thermal expansion, wherein the first coefficient of thermal expansion differs from the second coefficient of thermal expansion.

Clause 15. The method of any of clauses 11-14, wherein the first coefficient of thermal expansion is greater than the second coefficient of thermal expansion.

Clause 16. The method of any of clauses 11-15, wherein the first coefficient of thermal expansion is less than the second coefficient of thermal expansion.

Clause 17. A system for analysis of mechanical and thermal loading of a double-pin thermal-mechanical structure, the system comprising:

a test physical double-pin thermal-mechanical structure that is characterized by a first plurality of parameters;

a finite element model representative of the test physical double-pin thermal-mechanical structure that characterized by a second plurality of parameters;

a processor configured to perform operations comprising:

performing a thermal load test on the finite element model representative of the test physical double-pin thermal-mechanical structure over the first plurality of parameters, the second plurality of parameters, and over a range of operating temperatures that the test physical double-pin thermal-mechanical structure is expected to experience;

performing, concurrently or separately to the thermal load test, a mechanical stress test on the finite element model representative of the test physical double-pin thermal-mechanical structure over the plurality of parameters and over a range of operating temperatures that the test physical double-pin thermal-mechanical structure is expected to experience; and

determining that the thermal load test and the mechanical stress test meet a predetermined threshold,

wherein the test physical double-pin thermal-mechanical structure is designed based on the determining that the thermal load test and the mechanical stress test meet a predetermined threshold.

Clause 18. The system of clause 17, wherein the processor is further configured to perform operations comprising generating one or more coefficients that adjust the finite element model to represent the test physical double-pin thermal-mechanical structure under operating conditions.

Clause 19. The system of clause 17 or clause 18, wherein the processor is further configured to perform operations comprising generating a stress versus strain curve for each of the first parameters of the test physical double-pin thermal-mechanical over the range of operating temperatures.

Clause 20. The system of any of clauses 17-19, wherein the first plurality of parameters and the second plurality of parameters comprise one or more of: a fastener-to-fastener spacing, properties of materials that constitute the test physical double-pin thermal-mechanical structure, material behaviors of the materials that constitute the test physical double-pin thermal-mechanical structure, failure modes of the materials that constitute the test physical double-pin thermal-mechanical structure, bulk geometric features of the materials that constitute the test physical double-pin thermal-mechanical structure, application of the test physical double-pin thermal-mechanical structure, and combinations thereof.

Different examples of the apparatus(es) and method(s) disclosed herein include a variety of components, features, and functionalities. It should be understood that the various examples of the apparatus(es) and method(s) disclosed herein may include any of the components, features, and functionalities of any of the other examples of the apparatus(es) and method(s) disclosed herein in any combination, and all of such possibilities are intended to be within the scope of the present disclosure. Many modifications of examples set forth herein will come to mind to one skilled in the art to which the present disclosure pertains having the benefit of the teachings presented in the foregoing descriptions and the associated drawings.

Reference herein to "one example" means that one or more feature, structure, or characteristic described in connection with the example is included in at least one implementation. The phrase "one example" in various places in the specification may or may not be referring to the same example. As used herein, a system, apparatus, structure, article, element, component, or hardware "configured to" perform a specified function is indeed capable of performing the specified function without any alteration, rather than merely having potential to perform the specified function after further modification. In other words, the system, apparatus, structure, article, element, component, or hardware "configured to" perform a specified function is specifically selected, created, implemented, utilized, programmed, and/or designed for the purpose of performing the specified function. As used herein, "configured to" denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being "configured to" perform a particular function may additionally or alternatively be described as being "adapted to" and/or as being "operative to" perform that function.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of "less than 10" can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. -1, -2, -3, - 10, -20, -30, etc.

Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of A, B and C.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

Reference herein to "one example" means that one or more feature, structure, or characteristic described in connection with the example is included in at least one implementation. The phrase "one example" in various places in the specification may or may not be referring to the same example. As used herein, a system, apparatus, structure, article, element, component, or hardware "configured to" perform a specified function is indeed capable of performing the specified function without any alteration, rather than merely having potential to perform the specified function after further modification. In other words, the system, apparatus, structure, article, element, component, or hardware "configured to" perform a specified function is specifically selected, created, implemented, utilized, programmed, and/or designed for the purpose of performing the specified function. As used herein, "configured to" denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being "configured to" perform a particular function may additionally or alternatively be described as being "adapted to" and/or as being "operative to" perform that function.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

Although examples have been shown and described in this specification and figures, it would be appreciated that changes can be made to the illustrated and/or described examples without departing from their principles and spirit, the scope of which is defined by the following claims and their equivalents.

What is claimed is:

1. A method for analysis of mechanical and thermal loading of a double-pin thermal-mechanical structure, the method comprising:
obtaining a first plurality of parameters of a test physical double-pin thermal-mechanical structure;
obtaining a second plurality of parameters of a finite element model representative of the test physical double-pin thermal-mechanical structure;
performing a thermal load test on the finite element model representative of the test physical double-pin thermal-mechanical structure over the first plurality of parameters, the second plurality of parameters, and over a range of operating temperatures that the test physical double-pin thermal-mechanical structure is expected to experience;
performing, concurrently or separately to the thermal load test, a mechanical stress test on the finite element model representative of the test physical double-pin thermal-mechanical structure over the plurality of parameters and over a range of operating temperatures that the test physical double-pin thermal-mechanical structure is expected to experience;
determining that the thermal load test and the mechanical stress test meet a predetermined threshold; and
designing the test physical double-pin thermal-mechanical structure based on the determining that the thermal load test and the mechanical stress test meet a predetermined threshold.

2. The method of claim 1, further comprising generating one or more coefficients that adjust the finite element model to represent the test physical double-pin thermal-mechanical structure under operating conditions.

3. The method of claim 1, further comprising generating a stress versus strain curve for each of the first parameters of the test physical double-pin thermal-mechanical over the range of operating temperatures.

4. The method of claim 1, wherein the first plurality of parameters and the second plurality of parameters comprise one or more of: a fastener-to-fastener spacing, properties of materials that constitute the test physical double-pin thermal-mechanical structure, material behaviors of the materials that constitute the test physical double-pin thermal-mechanical structure, failure modes of the materials that constitute the test physical double-pin thermal-mechanical structure, bulk geometric features of the materials that constitute the test physical double-pin thermal-mechanical structure, application of the test physical double-pin thermal-mechanical structure, and combinations thereof.

5. The method of claim 1, wherein the double-pin thermal-mechanical structure comprises:
a first member comprising first material;
a second member comprising second material; and
a third member comprising the first material;
wherein the second member is at least partially between the first member and the third member,
wherein the second member is fastened to the first member and the third member,
wherein the first material differs from the second material, and
wherein the mechanical stress test is configured to mechanically load the first member, the second member, and the third member by applying equal and opposite force to protruding ends of the first member, the second member, and the third member.

6. The method of claim 1, wherein the double-pin thermal-mechanical structure comprises:
a first member comprising a first member protruding end and a first member non-protruding end and comprising first material;
a second member comprising a second member protruding end and a second member non-protruding end and comprising second material; and
a third member comprising a third member protruding end and a third member non-protruding end and comprising the first material;
wherein the second member is at least partially between the first member and the third member,
wherein the second member is fastened to the first member and the third member by a fastener secured through a first member through hole and a third member through hole,
wherein the first material differs from the second material, and
wherein the mechanical stress test is configured to mechanically load the first member, the second member, and the third member by applying equal and opposite force to the first member protruding end, the second member protruding end, and the third member protruding end.

7. The method of claim 6, wherein the first material has a first coefficient of thermal expansion,
wherein the second material has a second coefficient of thermal expansion, and
wherein the first coefficient of thermal expansion differs from the second coefficient of thermal expansion.

8. The method of claim 7, wherein the first coefficient of thermal expansion is greater than the second coefficient of thermal expansion or the first coefficient of thermal expansion is less than the second coefficient of thermal expansion.

9. The method of claim 6, wherein the first material comprises at least one metal, at least one non-metal, or a composite laminate.

10. The method of claim 6, wherein the second material comprises at least one metal, at least one non-metal, or at least one composite laminate.

11. A method for analysis of mechanical and thermal loading of structures, the method comprising:
constructing a test physical double-pin thermal-mechanical structure by fastening a second member to a first member and a third member to form a device for the analysis, wherein the second member is at least partially between the first member and the third member;
thermally loading the device by raising or lowering a temperature of the first, second, and third members;
mechanically loading the device by applying equal and opposite force to protruding ends of the first member, the second member, and the third member; and
measuring a failure load or other relevant physical parameter of the device.

12. The method of claim 11, further comprising:
determining one or more coefficient corrections for a thermal loading analysis based on the failure load or other relevant physical parameters of the device that are measured.

13. The method of claim 11, further comprising:
determining one or more coefficient corrections for a combined mechanical and thermal loading analysis based on the failure load or other relevant physical parameters of the device that are measured.

14. The method of claim 11, wherein the test physical double-pin thermal-mechanical structure comprises a first material that has a first coefficient of thermal expansion and a second material that has a second coefficient of thermal expansion, wherein the first coefficient of thermal expansion differs from the second coefficient of thermal expansion.

15. The method of claim 14, wherein the first coefficient of thermal expansion is greater than the second coefficient of thermal expansion.

16. The method of claim 14, wherein the first coefficient of thermal expansion is less than the second coefficient of thermal expansion.

17. A system for analysis of mechanical and thermal loading of a double-pin thermal-mechanical structure, the system comprising:
a test physical double-pin thermal-mechanical structure that is characterized by a first plurality of parameters;
a finite element model representative of the test physical double-pin thermal-mechanical structure that characterized by a second plurality of parameters;
a processor configured to perform operations comprising:
performing a thermal load test on the finite element model representative of the test physical double-pin thermal-mechanical structure over the first plurality of parameters, the second plurality of parameters, and over a range of operating temperatures that the test physical double-pin thermal-mechanical structure is expected to experience;
performing, concurrently or separately to the thermal load test, a mechanical stress test on the finite element model representative of the test physical double-pin thermal-mechanical structure over the plurality of parameters and over a range of operating temperatures that the test physical double-pin thermal-mechanical structure is expected to experience; and
determining that the thermal load test and the mechanical stress test meet a predetermined threshold,
wherein the test physical double-pin thermal-mechanical structure is designed based on the determining that the thermal load test and the mechanical stress test meet a predetermined threshold.

18. The system of claim 17, wherein the processor is further configured to perform operations comprising generating one or more coefficients that adjust the finite element model to represent the test physical double-pin thermal-mechanical structure under operating conditions.

19. The system of claim 17, wherein the processor is further configured to perform operations comprising generating a stress versus strain curve for each of the first parameters of the test physical double-pin thermal-mechanical over the range of operating temperatures.

20. The system of claim 17, wherein the first plurality of parameters and the second plurality of parameters comprise one or more of: a fastener-to-fastener spacing, properties of materials that constitute the test physical double-pin thermal-mechanical structure, material behaviors of the materials that constitute the test physical double-pin thermal-mechanical structure, failure modes of the materials that constitute the test physical double-pin thermal-mechanical structure, bulk geometric features of the materials that constitute the test physical double-pin thermal-mechanical structure, application of the test physical double-pin thermal-mechanical structure, and combinations thereof.
